(19) United States
(12) Patent Application Publication
(10) Pub. No.: US 2026/0362110 A1
(43) Pub. Date: Nov. 12, 2026

(54) PUBLIC WARNING SYSTEM NOTIFICATIONS

(71) Applicant: QUALCOMM Incorporated, San Diego, CA (US)

(72) Inventors: Amer CATOVIC, San Diego, CA (US); Osama LOTFALLAH, San Diego, CA (US); Lenaig Genevieve CHAPONNIERE, La Jolla, CA (US)

(21) Appl. No.: 19/665,608

(22) Filed: May 1, 2026

Related U.S. Application Data
(60) Provisional application No. 63/802,522, filed on May 8, 2025.

(51) Int. Cl. H04W 4/90; H04W 4/021

(52) U.S. Cl. CPC H04W 4/90; H04W 4/021

(57) ABSTRACT

Various aspects of the present disclosure generally relate to wireless communication. In some aspects, a user equipment (UE) may receive a first public warning system (PWS) message, wherein the first PWS message includes a first message identifier and initial geo-fencing information indicating an initial geo-fencing area. The UE may refrain from displaying the first PWS message based on a determination that the UE is located outside of the initial geo-fencing area. The UE may receive a second PWS message, wherein the second PWS message includes a second message identifier and message content. The UE may display the message content of the second PWS message based on a determination that the first message identifier matches the second message identifier. Numerous other aspects are described.

### CROSS-REFERENCE TO RELATED APPLICATION

This Patent Application claims priority to U.S. Provisional Patent Application No. 63/802,522, filed on May 8, 2025, entitled “PUBLIC WARNING SYSTEM NOTIFICATIONS,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with public warning system notifications.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

Public Warning System (PWS) is a mechanism designed to distribute warning notifications over wireless networks, providing timely and accurate alerts, warnings, and information regarding disasters and emergencies such as earthquakes, tsunamis, hurricanes, and wildfires. PWS may include different messaging types and features that may vary according to geographic regions, emergency types, wireless network types, or user equipment (UE) types, among other examples. PWS notifications may include one or more elements, including indications of an event description, an area affected, a recommended action, an expiration time, or a sending agency, among other examples. In some examples, PWS messages may be transmitted in two steps: an initial “primary notification” followed by a “secondary notification” that may include more detailed information or content.

### SUMMARY

The systems, methods, and devices of this disclosure each have several innovative aspects, no single one of which is solely responsible for the desirable attributes disclosed herein.

Some aspects described herein relate to a user equipment (UE). The UE may include a processing system. The processing system may include one or more processors and one or more code-storing memories coupled with the one or more processors. The processing system may be configured to cause the UE to receive a first public warning system (PWS) message, wherein the first PWS message includes a first message identifier and initial geo-fencing information indicating an initial geo-fencing area. The processing system may be configured to cause the UE to refrain from displaying and to store the first PWS message based on a determination that the UE is located outside of the initial geo-fencing area, wherein the first PWS message is stored by the UE. The processing system may be configured to cause the UE to receive a second PWS message, wherein the second PWS message includes a second message identifier and message content. The processing system may be configured to cause the UE to discard the first PWS message based on a determination that the first message identifier matches the second message identifier.

Some aspects described herein relate to a radio access network (RAN) network node. The RAN network node may include a processing system. The processing system may include one or more processors and one or more code-storing memories coupled with the one or more processors. The processing system may be configured to cause the RAN network node to transmit, to a UE, a first PWS message, wherein the first PWS message includes a first message identifier and initial geo-fencing information indicating an initial geo-fencing area. The processing system may be configured to cause the RAN network node to transmit, to the UE, a second PWS message, wherein the second PWS message includes a second message identifier and message content, and wherein the first message identifier matches the second message identifier.

Some aspects described herein relate to a core network node. The core network node may include a processing system. The processing system may include one or more processors and one or more code-storing memories coupled with the one or more processors. The processing system may be configured to cause the core network node to receive, from a cell broadcast entity, a PWS broadcast request. The processing system may be configured to cause the core network node to transmit a first PWS message request based on the PWS broadcast request, wherein the first PWS message request includes a first message identifier and initial geo-fencing information indicating an initial geo-fencing area. The processing system may be configured to cause the core network node to transmit a second PWS message request based on the PWS broadcast request, wherein the second PWS message request includes a second message identifier and message content, and wherein the first message identifier matches the second message identifier.

Some aspects described herein relate to a method of wireless communication performed by a UE. The method may include receiving a first PWS message, wherein the first PWS message includes a first message identifier and initial geo-fencing information indicating an initial geo-fencing area. The method may include refraining from displaying the first PWS message based on a determination that the UE is located outside of the initial geo-fencing area, wherein the first PWS message is stored by the UE. The method may include receiving a second PWS message, wherein the second PWS message includes a second message identifier and message content. The method may include discarding the first PWS message based on a determination that the first message identifier matches the second message identifier.

Some aspects described herein relate to a method of wireless communication performed by a RAN network node. The method may include transmitting, to a UE, a first PWS message, wherein the first PWS message includes a first message identifier and initial geo-fencing information indicating an initial geo-fencing area. The method may include transmitting, to the UE, a second PWS message, wherein the second PWS message includes a second message identifier and message content, and wherein the first message identifier matches the second message identifier.

Some aspects described herein relate to a method of wireless communication performed by a core network node. The method may include receiving, from a cell broadcast entity, a PWS broadcast request. The method may include transmitting a first PWS message request based on the PWS broadcast request, wherein the first PWS message request includes a first message identifier and initial geo-fencing information indicating an initial geo-fencing area. The method may include transmitting a second PWS message request based on the PWS broadcast request, wherein the second PWS message request includes a second message identifier and message content, and wherein the first message identifier matches the second message identifier.

Some aspects described herein relate to a non-transitory computer-readable medium that stores a set of instructions for wireless communication by a UE. The set of instructions, when executed by one or more processors of the UE, may cause the UE to receive a first PWS message, wherein the first PWS message includes a first message identifier and initial geo-fencing information indicating an initial geo-fencing area. The set of instructions, when executed by one or more processors of the UE, may cause the UE to refrain from displaying the first PWS message based on a determination that the UE is located outside of the initial geo-fencing area, wherein the first PWS message is stored by the UE. The set of instructions, when executed by one or more processors of the UE, may cause the UE to receive a second PWS message, wherein the second PWS message includes a second message identifier and message content. The set of instructions, when executed by one or more processors of the UE, may cause the UE to discard the first PWS message based on a determination that the first message identifier matches the second message identifier.

Some aspects described herein relate to a non-transitory computer-readable medium that stores a set of instructions for wireless communication by a RAN network node. The set of instructions, when executed by one or more processors of the RAN, may cause the RAN to transmit, to a UE, a first PWS message, wherein the first PWS message includes a first message identifier and initial geo-fencing information indicating an initial geo-fencing area. The set of instructions, when executed by one or more processors of the RAN, may cause the RAN to transmit, to the UE, a second PWS message, wherein the second PWS message includes a second message identifier and message content, and wherein the first message identifier matches the second message identifier.

Some aspects described herein relate to a non-transitory computer-readable medium that stores a set of instructions for wireless communication by a core network node. The set of instructions, when executed by one or more processors of the core network node, may cause the core network node to receive, from a cell broadcast entity, a PWS broadcast request. The set of instructions, when executed by one or more processors of the core network node, may cause the core network node to transmit a first PWS message request based on the PWS broadcast request, wherein the first PWS message request includes a first message identifier and initial geo-fencing information indicating an initial geo-fencing area. The set of instructions, when executed by one or more processors of the core network node, may cause the core network node to transmit a second PWS message request based on the PWS broadcast request, wherein the second PWS message request includes a second message identifier and message content, and wherein the first message identifier matches the second message identifier.

Some aspects described herein relate to an apparatus for wireless communication. The apparatus may include means for receiving a first PWS message, wherein the first PWS message includes a first message identifier and initial geo-fencing information indicating an initial geo-fencing area. The apparatus may include means for refraining from displaying the first PWS message based on a determination that the UE is located outside of the initial geo-fencing area, wherein the first PWS message is stored by the UE. The apparatus may include means for receiving a second PWS message, wherein the second PWS message includes a second message identifier and message content. The apparatus may include means for discarding the first PWS message based on a determination that the first message identifier matches the second message identifier.

Some aspects described herein relate to an apparatus for wireless communication. The apparatus may include means for transmitting, to a UE, a first PWS message, wherein the first PWS message includes a first message identifier and initial geo-fencing information indicating an initial geo-fencing area. The apparatus may include means for transmitting, to the UE, a second PWS message, wherein the second PWS message includes a second message identifier and message content, and wherein the first message identifier matches the second message identifier.

Some aspects described herein relate to an apparatus for wireless communication. The apparatus may include means for receiving, from a cell broadcast entity, a PWS broadcast request. The apparatus may include means for transmitting a first PWS message request based on the PWS broadcast request, wherein the first PWS message request includes a first message identifier and initial geo-fencing information indicating an initial geo-fencing area. The apparatus may include means for transmitting a second PWS message request based on the PWS broadcast request, wherein the second PWS message request includes a second message identifier and message content, and wherein the first message identifier matches the second message identifier.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by the accompanying drawings. Details of one or more implementations of the subject matter described in this disclosure are set forth in the accompanying drawings, and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram of an example of a core network configured to provide network slicing.

FIG. 3 is a diagram of an example implementation associated with public warning system (PWS) notifications.

FIGS. 4A-4B are diagrams of an example implementation associated with PWS notifications.

FIGS. 5A-5B are diagrams of example implementations associated with PWS notifications.

FIG. 6 is a diagram illustrating an example process performed, for example, at a user equipment (UE) or an apparatus of a UE.

FIG. 7 is a diagram illustrating an example process performed, for example, at a radio access network (RAN) network node or an apparatus of a RAN network node.

FIG. 8 is a diagram illustrating an example process performed, for example, at a core network node or an apparatus of a core network node.

FIGS. 9-11 are diagrams of example apparatuses for wireless communication.

### DETAILED DESCRIPTION

Public Warning System (PWS) is a mechanism designed to distribute warning notifications over wireless networks, providing timely and accurate alerts, warnings, and information regarding disasters and emergencies such as earthquakes, tsunamis, hurricanes, and wildfires. PWS may include different messaging types and features that may vary according to geographic region, emergency type, wireless network type, or user equipment (UE) type, among other examples. For example, various geographic regions may utilize different PWS types, such as the Earthquake and Tsunami Warning System (ETWS) in Japan, the Korean Public Alert System (KPAS) in Korea, and the Commercial Mobile Alert System (CMAS) in the United States of America, among other examples. Additionally, the CMAS may include different classes of PWS notifications, including presidential notifications, imminent threat notifications, public safety notifications, child abduction emergency notifications, or state or local test notifications, among other examples.

PWS messages (e.g., PWS notifications) may include one or more elements, including indications of an event description, an area affected, a recommended action, an expiration time, or a sending agency, among other examples, which may be broadcast using system information block (SIB) messages in a broadcast channel. In some examples, PWS messages may be transmitted in two steps: an initial primary notification (PN) (e.g., a first PWS message) that may include only immediately-relevant details of an emergency followed by a secondary notification (SN) (e.g., a second PWS message) that may include more detailed information or content related to emergency. For example, a PN may include a warning message that a tsunami is imminent, and an SN may include more detailed evacuation instructions. In some examples, however, a UE may receive the SN prior to receiving the PN.

In some examples, the SIB message may include warning area coordinates (WAC) information, which may include geo-fencing information (e.g., a virtual boundary created using geographic coordinates). For example, by including geo-fencing information, the PWS message may ensure that PWS message content is only displayed to users within a specific geographic area in order to prevent alarms in locations not affected by the emergency. In some examples, PWS message systems may not include WAC information in both primary and secondary notifications. This may lead to geo-fencing information only accompanying a single notification, resulting in potential ambiguities in interpreting the geo-fencing information.

For example, a UE may receive a PWS message that does not include geo-fencing information. As a result, the UE may determine whether to display, store, or discard PWS messages based on its current location relative to previously-received geo-fencing information or based on a lack of received geo-fencing information. For example, a UE may receive an SN with more comprehensive geo-fencing data than a previously-received PN, or the UE may receive a PN or an SN that does not include geo-fencing information.

Furthermore, there may be an absence of linkage information between PNs and SNs. For example, although both notifications may pertain to the same event, the UE may be unable to determine whether multiple received PWS messages are related to the same event, thereby complicating the UE's ability to manage and correlate PWS message effectively. Additionally, in some examples, where the UE is unable to determine whether a received PWS message is a PN or an SN, the UE may be unable to determine whether to display or store the PWS message.

Various aspects relate generally to improving the handling of PWS message by UEs. Some aspects more specifically address how UEs may manage PWS messages based on geo-fencing data, message content, and message identifier or serial number identification. In some aspects, the UE may receive a first PWS message with initial geo-fencing information and a second PWS message which may include more detailed geo-fencing data. The UE may refrain from displaying the first PWS message if the UE is located outside the initial geo-fencing area, and the UE may store the first PWS message for potential future use. Upon receiving the second PWS message, the UE may compare the serial numbers of the messages to determine if they pertain to the same event. If the serial numbers match, the UE may discard the first PWS message. Alternatively, if the serial numbers match, the UE may display the content of the second PWS message, which may supersede the primary notification.

In some aspects, the second PWS message may provide subsequent geo-fencing information, and the UE may display the message content based upon the UE being inside the subsequent geo-fencing area. Additionally, the UE may discard or retain the first PWS message based on whether it is a PN or based on the comparative detail of geo-fencing information included in the second PWS message. For example, if the second PWS message includes a larger quantity of geo-fencing data than the first PWS message, the first PWS message may be discarded. Additionally, if the UE cannot determine its location, it may display the message content.

Particular aspects of the subject matter described in this disclosure can be implemented to realize one or more of the following advantages. By utilizing message identifier or serial number matching and geo-fencing information, the described techniques may improve the UE’s ability to prioritize and process relevant emergency notifications, thereby conserving processing resources by avoiding display or storage of irrelevant warnings. Additionally, by dynamically managing notifications based on geo-fencing data and serial number linkage, the system may reduce network resource consumption by minimizing the transmission and processing of redundant or irrelevant alerts. In this way, the system may adapt to regional emergency communication systems in PWS operations, thereby enabling efficient utilization of network and computing resources.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

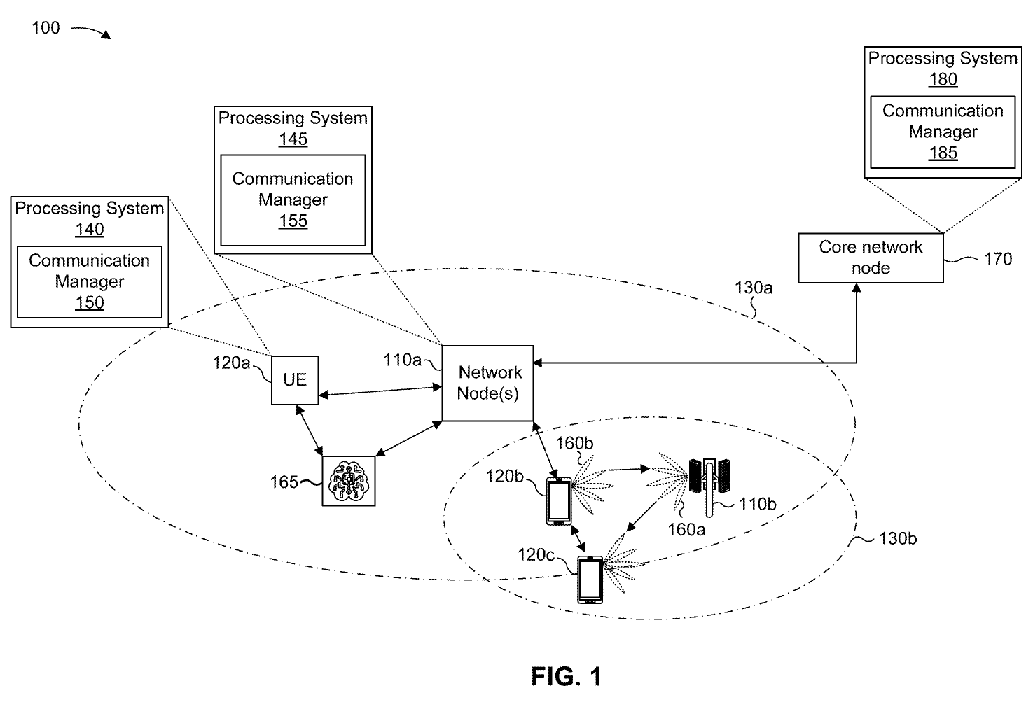

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110 (e.g., RAN network nodes), including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110. Additionally, in some examples, the wireless communication network 100 may include a core network node 170 that may support communications with the network nodes 110 (e.g., RAN network nodes), as described herein.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110, a UE 120, or a core network node 170 may include one or more devices, components, or systems that enable communication with other devices, components, or systems of the wireless communication network 100. For example, a UE 120, a network node 110, and a core network node 170 may each include one or more chips, system-on-chips (SoCs), chipsets, packages, or devices that individually or collectively constitute or comprise a processing system. As shown in FIG. 1, each UE 120 includes a processing system 140, each network node 110 includes a processing system 145, and each core network node 170 includes a processing system 180. A processing system (for example, the processing system 140, the processing system 145, or the processing system 180) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140, the processing system 145, and the processing system 180 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140, the processing system 145, and the processing system 180 may each include or be coupled with one or more modems (such as a cellular (for example, a 5G or 6G compliant) modem). In some examples, one or more processors of the processing system 140, the processing system 145, or the processing system 180 may include or implement one or more of the modems. The processing system 140, the processing system 145, and the processing system 180 also may include or be coupled with multiple radios (collectively “the radio”), multiple RF chains, or multiple transceivers, each of which may in turn be coupled with one or more of multiple antennas. In some examples, one or more processors of the processing system 140, the processing system 145, or the processing system 180 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140, by the processing system 145, or by the processing system 180). Additionally, the UE may incorporate a location determination module that may utilize one or more of global positioning system (GPS) data, network-based location services, or devices sensors to ascertain (e.g., via the processing system 145) a geographic position of the UE.

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUs.

In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)- reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

In some aspects, the UE 120 may include a communication manager 150. As described in more detail elsewhere herein, the communication manager 150 may receive a first PWS message, wherein the first PWS message includes a first message identifier and initial geo-fencing information indicating an initial geo-fencing area; refrain from displaying the first PWS message based on a determination that the UE 120 is located outside of the initial geo-fencing area, wherein the first PWS message is stored by the UE; receive a second PWS message, wherein the second PWS message includes a second message identifier and message content; and discard the first PWS message based on a determination that the first message identifier matches the second message identifier. Additionally, or alternatively, the communication manager 150 may perform one or more other operations described herein.

In some aspects, the RAN network node (e.g., network node 110) may include a communication manager 155. As described in more detail elsewhere herein, the communication manager 155 may transmit, to a UE 120, a first PWS message, wherein the first PWS message includes a first message identifier and initial geo-fencing information indicating an initial geo-fencing area; and transmit, to the UE 120, a second PWS message, wherein the second PWS message includes a second message identifier and message content, and wherein the first message identifier matches the second message identifier. Additionally, or alternatively, the communication manager 155 may perform one or more other operations described herein.

In some aspects, the core network node 170 may include a communication manager 185. As described in more detail elsewhere herein, the communication manager 185 may receive, from a cell broadcast entity (CBE) (e.g., CBE 270), a PWS broadcast request; transmit a first PWS message request based on the PWS broadcast request, wherein the first PWS message request includes a first message identifier and initial geo-fencing information indicating an initial geo-fencing area; and transmit a second PWS message request based on the PWS broadcast request, wherein the second PWS message request includes a second message identifier and message content, and wherein the first message identifier matches the second message identifier. Additionally, or alternatively, the communication manager 185 may perform one or more other operations described herein.

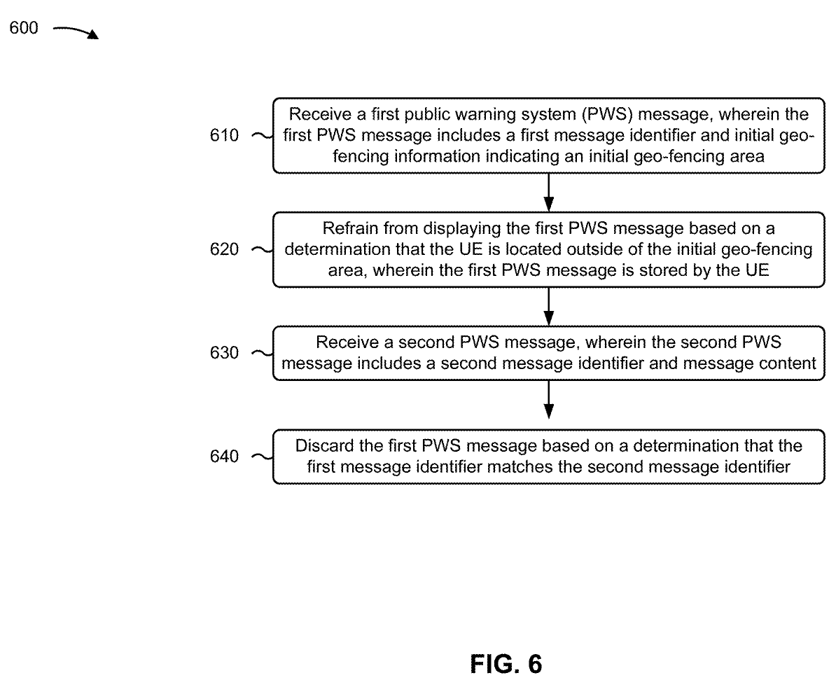

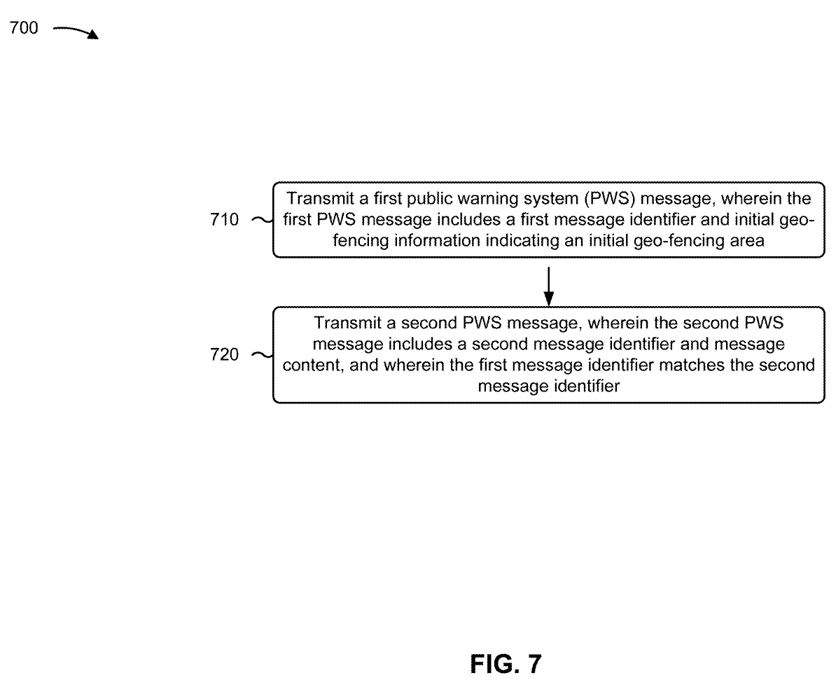

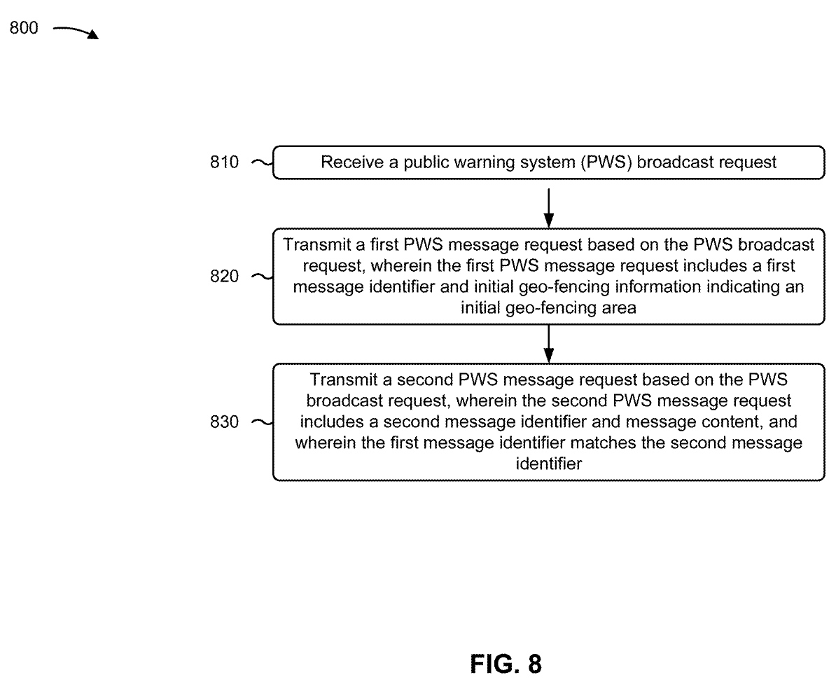

The network node 110, the processing system 145 of the network node 110, the UE 120, the processing system 140 of the UE 120, the processing system 180 of the core network node 170 or any other component(s) of FIG. 1 may implement one or more techniques or perform one or more operations associated with PWS notifications, as described in more detail elsewhere herein. For example, the processing system 145 of the network node 110, the processing system 140 of the UE 120, or the processing system 180 of the core network node 170 may perform or direct operations of, for example, process 600 of FIG. 6, process 700 of FIG. 7, process 800 of FIG. 8, or other processes as described herein (alone or in conjunction with one or more other processors). In some aspects, the RAN network node described herein is the network node 110, is included in the network node 110, or includes one or more components of the network node 110 shown in FIG. 1. Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. Memory of the core network node 170 may store data and program code (or instructions) for the core network node 170. In some examples, the memory of the UE 120, the memory of the network node 110, or the memory of the core network node 170 may include a non-transitory computer-readable medium storing a set of instructions for wireless communication. For example, the set of instructions, when executed by one or more processors (for example, of the processing system 145 the processing system 140, or the processing system 180) of the network node 110, the UE 120, or the core network node 170, may cause the one or more processors to perform process 600 of FIG. 6, process 700 of FIG. 7, process 800 of FIG. 8, or other processes as described herein. In some examples, executing instructions may include running the instructions, converting the instructions, compiling the instructions, or interpreting the instructions, among other examples.

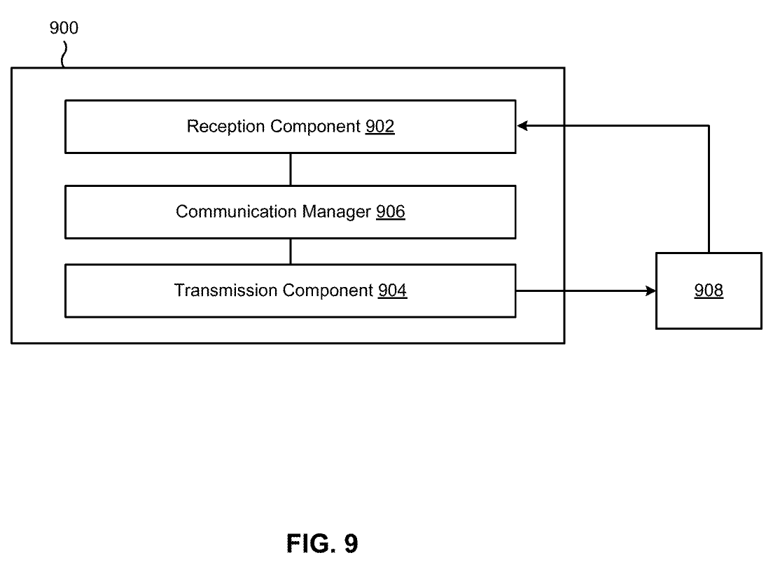

In some aspects, the UE 120 includes means for receiving a first PWS message, wherein the first PWS message includes a first message identifier and initial geo-fencing information indicating an initial geo-fencing area; means for refraining from displaying the first PWS message based on a determination that the UE 120 is located outside of the initial geo-fencing area; means for storing the first PWS message; means for receiving a second PWS message, wherein the second PWS message includes a second message identifier and message content; or means for discarding the first PWS message based on a determination that the first message identifier matches the second message identifier. The means for the UE 120 to perform operations described herein may include, for example, one or more of communication manager 150, processing system 140, a radio, one or more RF chains, one or more transceivers, one or more antennas, one or more modems, a reception component (for example, reception component 902 depicted and described in connection with FIG. 9), or a transmission component (for example, transmission component 904 depicted and described in connection with FIG. 9), among other examples.

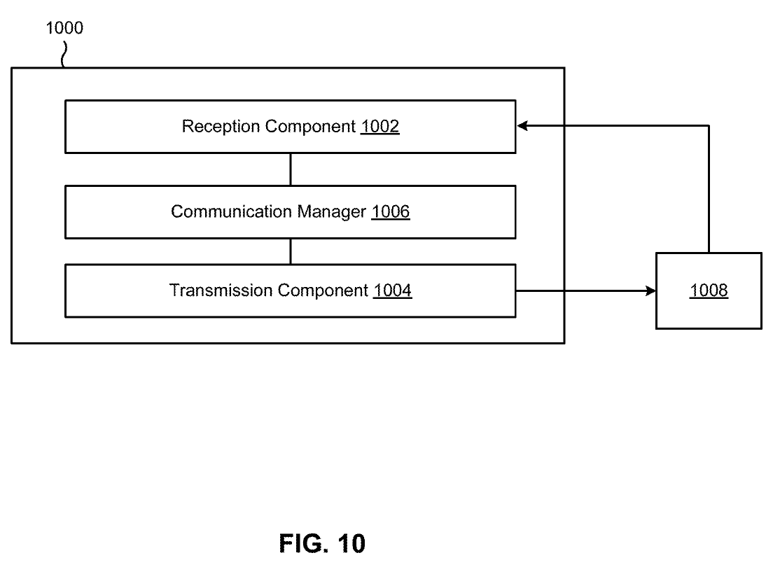

In some aspects, the RAN network node (e.g., network node 110) includes means for transmitting, to a UE 120, a first PWS message, wherein the first PWS message includes a first message identifier and initial geo-fencing information indicating an initial geo-fencing area; or means for transmitting, to the UE 120, a second PWS message, wherein the second PWS message includes a second message identifier and message content, and wherein the first message identifier matches the second message identifier. The means for the RAN network node to perform operations described herein may include, for example, one or more of communication manager 155, processing system 145, a radio, one or more RF chains, one or more transceivers, one or more antennas, one or more modems, a reception component (for example, reception component 1002 depicted and described in connection with FIG. 10), or a transmission component (for example, transmission component 1004 depicted and described in connection with FIG. 10), among other examples.

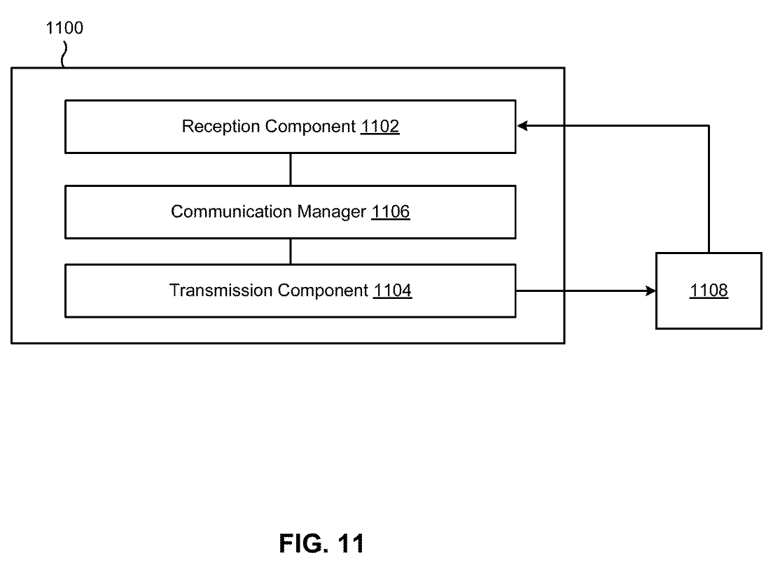

In some aspects, the core network node 170 includes means for receiving, from a CBE (e.g., CBE 270), a PWS broadcast request; means for transmitting a first PWS message request based on the PWS broadcast request, wherein the first PWS message request includes a first message identifier and initial geo-fencing information indicating an initial geo-fencing area; or means for transmitting a second PWS message request based on the PWS broadcast request, wherein the second PWS message request includes a second message identifier and message content, and wherein the first message identifier matches the second message identifier. The means for the core network node 170 to perform operations described herein may include, for example, one or more of communication manager 185, processing system 180, a radio, one or more RF chains, one or more transceivers, one or more antennas, one or more modems, a reception component (for example, reception component 1102 depicted and described in connection with FIG. 11), or a transmission component (for example, transmission component 1104 depicted and described in connection with FIG. 11), among other examples.

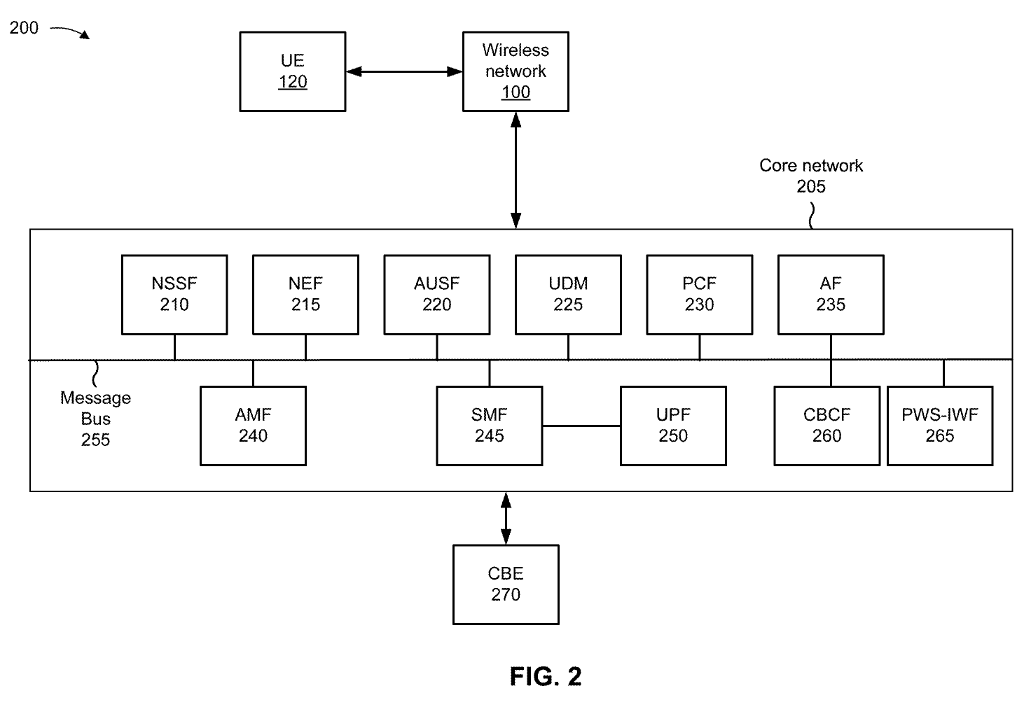

FIG. 2 is a diagram of an example 200 of a core network 205 configured to provide network slicing. As shown in FIG. 2, example 200 may include a UE 120, a wireless communication network 100, and a core network 205. Devices or networks of example 200 may interconnect via wired connections, wireless connections, or a combination thereof.

The wireless communication network 100 may support, for example, a cellular radio access technology (RAT). The network 100 may include one or more network nodes, such as base stations (e.g., base transceiver stations, radio base stations, node Bs, eNodeBs (eNBs), gNodeBs (gNBs), base station subsystems, cellular sites, cellular towers, access points, TRPs, radio access nodes, macrocell base stations, microcell base stations, picocell base stations, femtocell base stations, or similar types of devices) and other network nodes that can support wireless communication for the UE 120. The network 100 may transfer traffic between the UE 120 (e.g., using a cellular RAT), one or more network nodes (e.g., using a wireless interface or a backhaul interface, such as a wired backhaul interface), or the core network 205. The wireless communication network 100 may provide one or more cells that cover geographic areas.

In some aspects, the wireless communication network 100 may perform scheduling or resource management for the UE 120 covered by the network 100 (e.g., the UE 120 covered by a cell provided by the wireless communication network 100). In some aspects, the wireless communication network 100 may be controlled or coordinated by a network controller, which may perform load balancing or network-level configuration, among other examples. As described above in connection with FIG. 1, the network controller may communicate with the network 100 via a wireless or wireline backhaul. In some aspects, the network 100 may include a network controller, an SON module or component, or a similar module or component. Accordingly, the network 100 may perform network control, scheduling, or network management functions (e.g., for uplink, downlink, or sidelink communications of the UE 120 covered by the network 100).

In some aspects, the core network 205 may include an example functional architecture in which systems or methods described herein may be implemented. For example, the core network 205 may include an example architecture of a fifth generation (5G) next generation (NG) core network included in a 5G wireless telecommunications system. Although the example architecture of the core network 205 shown in FIG. 2 may be an example of a service-based architecture, in some aspects, the core network 205 may be implemented as a reference-point architecture or a 4G core network, among other examples.

As shown in FIG. 2, the core network 205 may include a number of functional elements. The functional elements may include, for example, a network slice selection function (NSSF) 210, a network exposure function (NEF) 215, an authentication server function (AUSF) 220, a unified data management (UDM) component 225, a policy control function (PCF) 230, an application function (AF) 235, an access and mobility management function (AMF) 240, a session management function (SMF) 245, a user plane function (UPF) 250, a cell broadcast center function (CBCF) 260, or a PWS interworking function (PWS-IWF) 265, among other examples. These functional elements may be communicatively connected via a message bus 255. Each of the functional elements shown in FIG. 2 may be implemented on one or more devices associated with a wireless telecommunications system. In some implementations, one or more of the functional elements may be implemented on physical devices, such as an access point, a base station, or a gateway, among other examples. In some implementations, one or more of the functional elements may be implemented on a computing device of a cloud computing environment. Additionally, in some examples, the CBCF 260 and the PWS-IWF 265 may be integrated in a single component, or the CBCF 260 and the PWS-IWF 265 may be located in separate components and may be communicatively connected via the message bus 255. Additionally, or alternatively, in some examples, the PWS-IWSF 265 may be included in the CBCF 260.

The NSSF 210 may include one or more devices that select network slice instances for the UE 120. Network slicing is a network architecture model in which logically distinct network slices operate using common network infrastructure. For example, several network slices may operate as isolated end-to-end networks customized to satisfy different target service standards for different types of applications executed, at least in part, by the UE 120 or communications to and from the UE 120. Network slicing may efficiently provide communications for different types of services with different service standards.

The NSSF 210 may determine a set of network slice policies to be applied at the wireless communication network 100. For example, the NSSF 210 may apply one or more UE route selection policy (URSP) rules. In some aspects, the NSSF 210 may select a network slice based on a mapping of a data network name (DNN) field included in a route selection description (RSD) to the DNN field included in a traffic descriptor selected by the UE 120. By providing network slicing, the NSSF 210 allows an operator to deploy multiple substantially independent end-to-end networks potentially with the same infrastructure. In some implementations, each slice may be customized for different services.

The NEF 215 may include one or more devices that support exposure of capabilities or events in the wireless telecommunications system to help other entities in the wireless telecommunications system discover network services. The AUSF 220 may include one or more devices that act as an authentication server and support the process of authenticating the UE 120 in the wireless telecommunications system.

The UDM 225 may include one or more devices that store user data and profiles in the wireless telecommunications system. In some aspects, the UDM 225 may be used for fixed access or mobile access, among other examples, in the core network 205.

The PCF 230 may include one or more devices that provide a policy framework that incorporates network slicing, roaming, packet processing, or mobility management, among other examples. In some aspects, the PCF 230 may include one or more URSP rules used by the NSSF 210 to select network slice instances for the UE 120.

The AF 235 may include one or more devices that support application influence on traffic routing, access to the NEF 215, or policy control, among other examples. The AMF 240 may include one or more devices that act as a termination point for non-access stratum (NAS) signaling or mobility management, among other examples. In some aspects, the AMF may request the NSSF 210 to select network slice instances for the UE 120, e.g., at least partially in response to a request for data service from the UE 120. Additionally, in some examples the AMF 240 may be incorporated into or may be in communication with an AMF network node that is incorporated in or in communication with the core network 205. In some examples, the AMF network node, as part of the core network 205, may receive messages or signaling from the CBE 270. Additionally, or alternatively, in some examples, the AMF 240 may be a mobility management function or may be related to a mobility management function.

The SMF 245 may include one or more devices that support the establishment, modification, and release of communication sessions in the wireless telecommunications system. For example, the SMF 245 may configure traffic steering policies at the UPF 250 or enforce user equipment internet protocol (IP) address allocation and policies, among other examples. In some aspects, the SMF 245 may provision the network slice instances selected by the NSSF 210 for the UE 120.

The UPF 250 may include one or more devices that serve as an anchor point for intraRAT or interRAT mobility. In some aspects, the UPF 250 may apply rules to packets, such as rules pertaining to packet routing, traffic reporting, or handling user plane QoS, among other examples.

In some examples, the CBCF 260 may be configured to manage cell broadcasts (e.g., broadcasts related to PWS message requests related to the PWS-IWF). Additionally, the PWS-IWF 265 may act as an interworking function between the core network 205 and a PWS (e.g., a CBE 270). Furthermore, the CBCF 260 may be a core network node that is in communication with the CBE, where the CBCF 260 may facilitate one or more RAN network nodes to transmit PWS messages.

The message bus 255 may be a logical or physical communication structure for communication among the functional elements. Accordingly, the message bus 255 may permit communication between two or more functional elements, whether logically (e.g., using one or more APIs, among other examples) or physically (e.g., using one or more wired or wireless connections).

Additionally, the CBE 270 may be in communication with the core network 205. In some examples, the CBE 270 may transmit emergency broadcast requests to the core network (e.g., to the CBCF 260 or the PWS-IWF 265), and the core network may transmit one or more PWS messages, to one or more UEs, related to the emergency broadcast request.

The number and arrangement of devices and networks shown in FIG. 2 are provided as an example. In practice, there may be additional devices or networks, fewer devices or networks, different devices or networks, or differently arranged devices or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of example 200 may perform one or more functions described as being performed by another set of devices of example 200.

As indicated above, FIG. 2 is provided as an example. Other examples may differ from what is described with regard to FIG. 2.

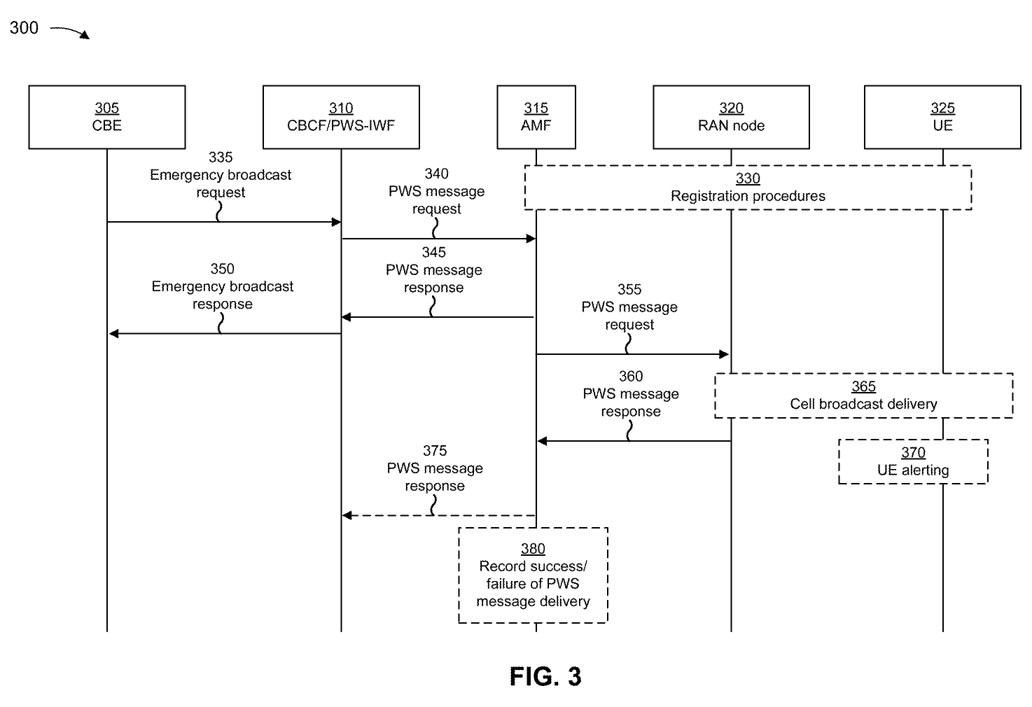

FIG. 3 is a diagram of an example implementation 300 associated with PWS notifications. As shown in FIG. 3, example implementation 300 includes a CBE 305, a CBCF/PWS-IWF node 310, an AMF 315, a RAN node 320 (e.g., a network node 110), and a UE 325 (e.g., a UE 120). These devices are described in more detail in connection with FIG. 1.

As shown by reference number 330, the AMF 315, RAN node 320, or UE 325 may perform registration procedures with the wireless network (e.g., wireless network 100). For example, the UE 325 may initiate a registration request to the AMF 315 through the RAN node 320. The AMF 315 (or one or more additional core network functions, including a mobility management entity (MME) or mobility management function, among other examples) may be responsible for managing the registration process, which may include authenticating the UE 325, allocating resources, and updating the wireless network with the UE's 325 current status. The RAN node 320 may facilitate the communication between the UE 325 and the AMF 315, ensuring that the registration request is transmitted efficiently and securely. This registration procedure enables subsequent communication and data exchange among the UE 325 and RAN node 320 and the RAN node 320 and AMF 315.

As shown by reference number 335, a CBE 305 may initiate an emergency broadcast request. In some aspects, initiating the broadcast process may include the CBE 305 initiating a preliminary verification process before sending an emergency broadcast request to ensure the message complies with emergency broadcast standards. The CBE 305 may send, and a CBCF/PWS-IWF 310 may receive, the emergency broadcast request.

The CBCF/PWS-IWF 310 may then process this request and generate a PWS message request. For example, the CBCF/PWS-IWF 310 may include a message identifier or a serial number, among other examples, in the PWS message request. As shown by reference number 340, the CBCF/PWS-IWF 310 may then transmit, and the AMF may receive, the PWS message request.

As shown by reference number 345, the AMF 315 may transmit, and the CBCF/PWS-IWF 310 may receive, a PWS message response. In some examples, the response from the AMF 315 may include the AMF 315 providing a detailed report or log in its PWS message response, indicating the current network status and any potential delivery issues. Additionally, or alternatively, the response from AMF may include the AMF 315 sending a confirmation of receipt along with the PWS message response, ensuring that the request was properly received and queued for transmission. This confirmation may include a timestamp and unique identifier for tracking purposes. As shown by reference number 350, upon receiving the PWS message response, the CBCF/PWS-IWF 310 may transmit, and the CBE 305 may receive, an emergency broadcast response (e.g., confirming the processing of the request).

As shown by reference number 355, the AMF 315 may transmit, and the RAN node 320 may receive, a PWS message request. Additionally, as shown by reference number 360, the RAN node 320 node may transmit, and the AMF 315 may receive, a PWS message response (e.g., configuring receipt of the PWS message request).

As shown by reference number 365, the RAN node 320 may broadcast (e.g., via SIB), and one or more UEs 325 may receive, a PWS message. Additionally, or alternatively, broadcasting via the RAN node 320 may include the RAN node 320 adjusting broadcast power levels to optimize the reach and clarity of the PWS message based on UE density in the designated area. In some examples, the PWS message may include message content, message identifier information, a serial number related to the PWS message, or expiration data, among other examples.

As shown by reference number 370, one or more UEs that received the PWS message may alert (e.g., display) the PWS message to a user of the UE. In some examples, where one or more conditions related to the PWS message are satisfied, the UE may display the PWS message to the user of the UE. For example, where the UE determines that the UE is located within a geo-located area indicated by the PWS message (e.g., via WAC information), the UE may display the PWS message to the user of the UE. Additionally, or alternatively, the UE may store the message according to one or more conditions.

As shown by reference number 375, the AMF 315 may transmit, and the CBCF/PWS-IWF 310 may receive, a response message indicating the success or failure of RAN node’s 320 broadcast of the PWS message. As shown by reference number 380, the AMF 315 may record the success or failure of the PWS message delivery.

Additionally, in some aspects, the CBE 305 may transmit, and the CBCF/PWS-IWF 310 may receive a second broadcast request. As a result, the CBCF/PWS-IWF 310 may transmit, and the AMF 315 may receive, a second PWS message request, which may include a different message identifier or a different serial number. The AMF 315 may transmit, and the RAN node 320 may receive, a second PWS message request, and the RAN node 320 may broadcast a second PWS message to one or more UEs. In some aspects, the second PWS message may provide additional, updated, or supplementary information relative to the information included in the original cell broadcast delivery. For example, the second PWS message may be an SN, whereas the previous PWS message may be a PN.

In some examples, PWS messages may include one or more elements, including indications of an event description, an area affected, a recommended action, an expiration time, or a sending agency, among other examples, which may be broadcast using SIB messages in a broadcast channel. In some examples, the SIB message may include WAC information, which may include geo-fencing information. For example, by including geo-fencing information, the PWS notification may ensure that PWS message content is only displayed to users within a specific geographic area in order to prevent alarms in locations not affected by the emergency.

When WAC information is provided with a PWS message (e.g., a PN or an SN), the UE may perform a location check to determine its position relative to the WAC area. If the UE is located within the WAC area, or if the UE is unable to ascertain its location, the UE may display the notification to the user. Conversely, if the UE is aware of its location and determines that the UE is outside the WAC area, the UE may refrain from displaying the notification to the user. In such scenarios, the UE may retain the notification until its validity period expires (e.g., one hour or twenty-four hours, among other examples). Upon expiration of the validity period, the UE may discard the notification.

Additionally, the UE may periodically check whether the UE has entered the WAC area for each stored notification. If the UE determines that the UE is within the WAC area during these checks, the UE may display the notification to the user. The frequency of these checks may be configured for each UE or for all UEs in communication with a network node. Furthermore, the network may have the capability to send a "geo-fencing trigger" message, prompting the UE to verify its position relative to the WAC area for one or more messages. For example, the geo-fencing trigger message may include a list of notifications for which checking is requested. In some examples, the geo-fencing trigger message may be distinguished by a dedicated message identifier, with each PWS message possessing a message identifier and serial number.

In some examples, PWS notification systems may not support the inclusion of WAC information in both PNs and SNs. This limitation may lead to geo-fencing information only accompanying a single notification, resulting in potential inefficiencies and inaccuracies in notification delivery. Additionally, or alternatively, the WAC information included with a PN may be smaller than the WAC information included with an SN. For example, the WAC information included with a PN may include 50 bytes of data (e.g., where the PN is included in a tenth SIB (SIB10) message), whereas the SN may include 1024 bytes of data.

However, in some examples, a UE may receive a PWS message that does not include geo-fencing information. As a result, the UE may determine whether to display, store, or discard PWS messages based on its current location relative to previously-received geo-fencing information or based on a lack of received geo-fencing information. For example, a UE may receive an SN with more comprehensive geo-fencing data than a previously-received PN, or the UE may receive a PN or an SN that does not include geo-fencing information. In another example, the UE may decide to display a PWS message that does not include geo-fencing information.

Furthermore, there may be an absence of linkage information between PNs and SNs. For example, although both notifications may pertain to the same event, the UE may be unable to determine whether multiple received notifications are related to the same event, thereby complicating the UE's ability to manage and correlate PWS notifications effectively. Additionally, in some examples, where the UE is unable to determine whether a received PWS message is a PN or an SN, the UE may be unable to determine whether to display or store the PWS message.

As indicated above, FIG. 3 is provided as an example. Other examples may differ from what is described with regard to FIG. 3.

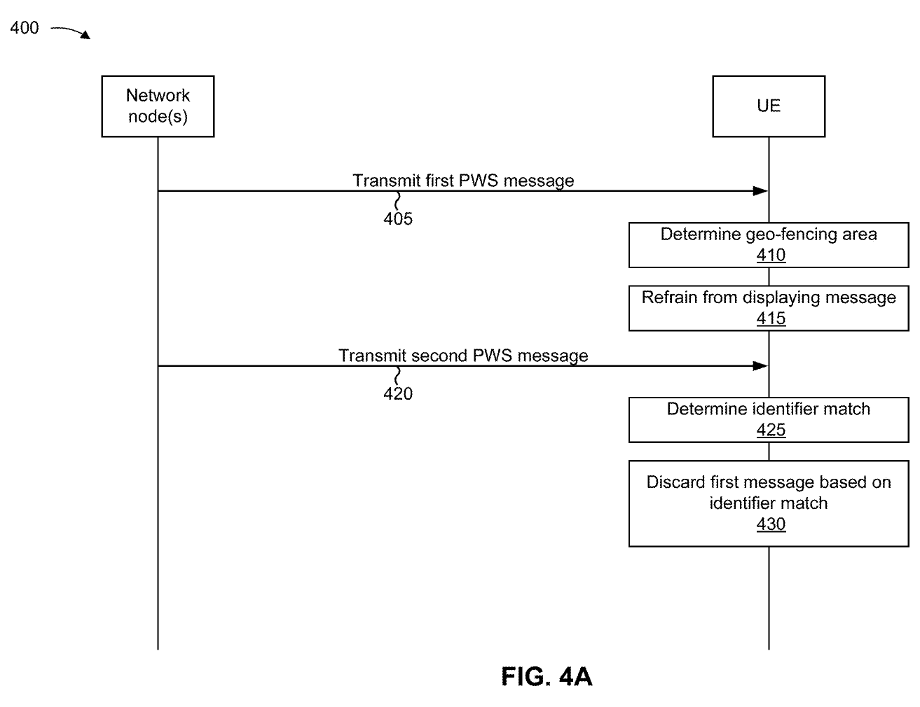

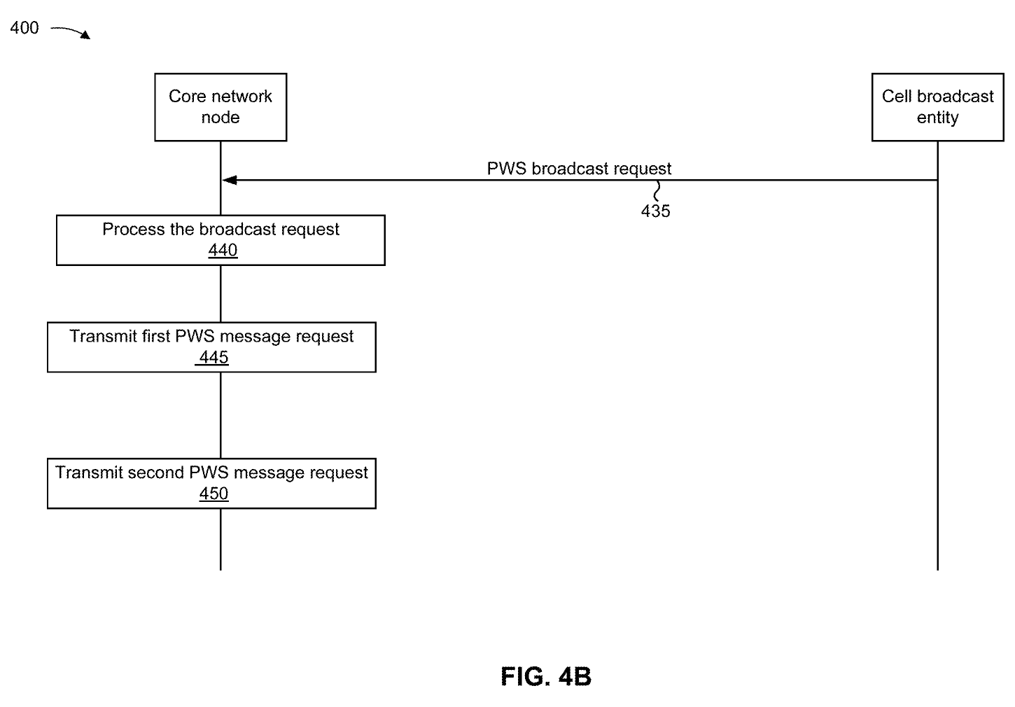

FIGS. 4A-4B are diagrams of an example implementation 400 associated with PWS notifications. As shown in FIG. 4A, example implementation 400 includes a network node (e.g., network node 110) in communication with a UE (e.g., UE 120).

In some aspects, as shown by reference number 405, the network node may transmit, and the UE may receive, a first PWS message, wherein the first PWS message includes a first message identifier (e.g., including a specific message identifier or a serial number) and initial geo-fencing information indicating an initial geo-fencing area. For example, the network node may send an emergency alert message with geo-fencing information to the UE, specifying a particular region affected by the alert. In this way, the first PWS message may increase the probability that UEs within the designated area receive relevant emergency notifications.

In some aspects, the first PWS message may be received in a first SIB and the second PWS message may be received in a second SIB. For example, the initial geo-fencing information may be embedded within SIB10 for PNs, while SNs may be included in an eleventh SIB (SIB11). Utilizing different SIBs for primary and secondary notifications may effectively segregate initial alerts (e.g., in a PN) and subsequent information (e.g., in an SN).

In some aspects, and as shown by reference number 410, the UE may determine whether the UE is located inside or outside of the initial geo-fencing area indicated by the first PWS message. For example, upon receiving the notification, the UE may check its current GPS location against the provided geo-fencing coordinates to ascertain its position relative to the affected area. In this way, determining the UE's location may prevent alerts from being displayed to users outside of the emergency zone.

In some aspects, and as shown by reference number 415, the UE may refrain from displaying the first PWS message based on a determination that the UE is located outside of the initial geo-fencing area. In some aspects, the UE may store the first PWS message based on a determination that the UE is located outside of the initial geo-fencing area. For example, the UE may display the stored first PWS message at a later time when the UE determines that the UE is located inside the initial geo-fencing area.

In some aspects, and as shown by reference number 420, the network node may transmit, and the UE may receive, a second PWS message, wherein the second PWS message includes a second message identifier (e.g., a specific message identifier or a serial number) and message content. For example, after the initial alert, the network node may send a detailed follow-up message with instructions on safety measures to the affected UEs. In this way, the second PWS message provides comprehensive information for user action during emergencies.

In some aspects, the second PWS message may include subsequent geo-fencing information indicating a subsequent geo-fencing area. For example, the network may specify a new or updated geo-fencing area in the secondary notification, reflecting updated safety boundaries. In some aspects, the subsequent geo-fencing area may be different from the initial geo-fencing area.

Alternatively, the second PWS message may not include subsequent geo-fencing information indicating a subsequent geo-fencing area. Additionally, in some aspects, the UE may store, prior to receiving the second PWS message, the first PWS message and refrain from discarding the first PWS message based on a determination that the first PWS message is not a PN. For example, because an SN may include more emergency information relative to a PN, the UE may store the first PWS message where the first message is not a PN (e.g., the first message may be an SN).

Additionally, or alternatively, the UE may store, prior to receiving the second PWS message, the first PWS message and discard the first PWS message based on a determination that the first PWS message is a PN. For example, because an SN may include more emergency information relative to a PN, the UE may discard the first PWS message where the first message is a PN.

Additionally, or alternatively, the UE may store, prior to receiving the second PWS message, the first PWS message and discard the first PWS message based upon receipt of the second PWS message. For example, upon acquiring new emergency details (e.g., included in an SN), the UE may discard previous alerts to maintain storage efficiency. In this way, discarding prior messages may optimize memory usage during emergency communications. Additionally, or alternatively, displaying the message content of the second PWS message may be further based on a determination that the UE is located inside of the initial geo-fencing area. For example, the UE may display the content of the second PWS message based upon a determination that the UE is located inside of the subsequent initial geo-fencing area and inside of the initial geo-fencing area (e.g., in a situation in which at least a portion of the initial geo-fencing area and the subsequent geo-fencing area overlap or share a geographic area). Additionally, or alternatively, where the second PWS message does not include subsequent geo-fencing information (e.g., indicating a subsequent geo-fencing area), the UE may utilize the initial geo-fencing area to determine whether to display the second PWS message, thereby ensuring that the UE user receives relevant information (e.g., in a circumstance in which the user was at least previously located within the geo-fencing area of the first PWS message).

In some aspects, as shown by reference number 425, the UE may determine whether the first message identifier matches the second message identifier. For example, the UE may compare a serial number of the first PWS message with a serial number of the second PWS message to verify that the first PWS message and the second PWS message both pertain to the same emergency (e.g., the serial number of the first PWS message is the same as the serial number of the second PWS message). In contrast, for example, if the serial number of the first PWS message does not match the serial number of the second PWS, this may indicate that the first PWS message does not pertain to the same emergency of the second PWS message. Additionally, or alternatively, the UE may compare a specific message identifier and a serial number of the first PWS message with a respective specific message identifier and a respective serial number of the second PWS message to verify that the first PWS message and the second PWS message pertain to the same emergency. For example, a serial number may serve as a linkage mechanism, enabling the UE to correlate multiple notifications as pertaining to the same emergency event. In this way, matching message identifiers ensures the coherence and relevance of the information delivered to the user.

In some aspects, as shown by reference number 430, the UE may discard the first PWS message based on a determination that the first message identifier matches the second message identifier. For example, upon acquiring new emergency details (e.g., included in an SN), the UE may discard previous alerts to maintain storage efficiency. In this way, discarding prior messages may optimize memory usage during emergency communications.

In some aspects, the UE may display the message content of the second PWS message based on a determination that the UE is located inside of the subsequent geo-fencing area (e.g., the geo-fencing area indicated in the second PWS message). For example, the UE may verify its current location within the updated boundaries before showing emergency details. Displaying messages based on updated geo-fencing areas may enhance the relevance of alerts to the UE user’s current situation or location. In some aspects, the UE may display the message content of a PWS message via a user interface component that is in communication with the communication manager. The user interface may provide visual, auditory, or haptic alerts to a UE user. For example, once the respective serial numbers of the first PWS message and the second PWS message are confirmed to match, the UE may display the more detailed safety instructions of the second PWS message (e.g., an SN) to a UE user, ensuring that the UE user receives actionable information about the emergency, while avoiding the processing overhead and the power consumption of the UE displaying irrelevant information.

Additionally, or alternatively, the UE may store, prior to receiving the second PWS message, the first PWS message and refrain from discarding the first PWS message based on a determination that the first PWS message is not a PN. For example, because an SN may include more emergency information relative to a PN, the UE may store the first PWS message where the first message is not a PN (e.g., where the first message may be an SN).

Additionally, or alternatively, the UE may store, prior to receiving the second PWS message, the first PWS message and discard the first PWS message based on a determination that the first PWS message is a primary notification. For example, because an SN may include more emergency information relative to a PN, the UE may discard the first PWS message where the first message is a PN, and as a result, may include irrelevant and insufficiently detailed information.

In some aspects, the UE may store, prior to receiving the second PWS message, the first PWS message and refrain from discarding the first PWS message based on a determination that the subsequent geo-fencing information includes a smaller quantity of data than the initial geo-fencing information. For example, where the second PWS message is less detailed than the first PWS message, the UE may determine that the first PWS message may be an SN. In some aspects, the UE may determine that the first PWS message is not a PN based on determining that the subsequent geo-fencing information includes a smaller quantity of data than the initial geo-fencing information. Accordingly, because the SN may include more information relative to a PN, the UE may store the SN so that it may be displayed if the UE enters the geo-located area. In this way, the UE may ensure that the UE user receives the most comprehensive emergency information available.

Additionally, or alternatively, the UE may store, prior to receiving the second PWS message, the first PWS message and discard the first PWS message based on a determination that the subsequent geo-fencing information includes a larger quantity of data than the initial geo-fencing information. For example, where the second PWS message is more detailed than the first PWS message, the UE may determine that the second PWS message may be an SN. In some aspects, the UE may determine that the first PWS message is a PN based on determining that the subsequent geo-fencing information includes a larger quantity of data than the initial geo-fencing information. Accordingly, because the SN may include more information relative to a PN, the UE may store the SN so that it may be displayed if the UE enters the geo-located area. In this way, the UE may ensure that the UE user receives the most comprehensive emergency information available.

Additionally, or alternatively, displaying the message content of the second PWS message may further include refraining from displaying the message content of the second PWS message based on a determination that the UE is located outside of the subsequent geo-fencing area. For example, the UE may store, but not display to a UE user, the detailed message if it is located outside of an updated emergency zone. Refraining from displaying messages outside of geo-fencing areas may prevent users from being distracted by irrelevant notifications and may avoid processing overhead and power consumption for irrelevant emergency information. Furthermore, the UE may store the second PWS message based on a determination that the first message identifier does not match the second message identifier or that the UE is located outside of the subsequent geo-fencing area. For example, the UE may archive mismatched messages as distinct alerts for future reference. Storing messages with unmatched identifiers may enable the UE to display a relevant PWS message based on the UE being located within a geo-fencing area of the relevant PWS message (e.g., where the UE moves from outside the geo-fencing area to inside the geo-fencing area).

Additionally, or alternatively, displaying the message content of the second PWS message may be further based on the UE being unable to determine a location of the UE. For example, the UE may present emergency information when its location services are unavailable, enabling UE users to receive alerts regardless of the UE being able to determine the UE’s location. In this way, displaying messages when location services are unavailable may increase the probability of alert delivery under various conditions.

In some aspects, the UE may not receive the second PWS message within a configured time period after receiving the first PWS message. Accordingly, the network node may transmit, and the UE may receive, a trigger message (e.g., a geo-fencing trigger message) instructing the UE to check whether the UE is located within in a geo-fencing area for receiving a second PWS message. For example, the network may periodically transmit a trigger prompting the UE to reassess its location against the stored geo-fencing data for relevant alerts. Initiating geo-fencing checks via trigger messages may ensure the UE maintains accurate positioning for emergency notifications.

Additionally, or alternatively, in some aspects, an SN may be received before a PN (e.g., the first PWS message may be an SN and the second PWS message may be a PN). For example, where an SN is received without prior receipt of a PN, the UE may display the secondary notification immediately if no geofencing information is present, thereby ensuring timely delivery of information. Alternatively, if geofencing information is included in the SN (e.g., the first PWS message), the UE may determine its location relative to the indicated geo-fencing area before displaying the notification.

As shown in FIG. 4B, and by reference number 435, a CBE may transmit, and a core network node may receive, a PWS broadcast request. For example, the CBE may send a broadcast request to the core network node when there is an imminent emergency for which the CBE may attempt to notify all UE users within a specific geographical area. Additionally, in some aspects, the core network node receiving the PWS broadcast request may be a CBCF or may be related to a CBCF.

In some aspects, as shown by reference number 440, the core network node may process the PWS broadcast request. In some aspects, the core network node may generate a first PWS message request, including a first message identifier (e.g., including a specific message identifier and a serial number) and initial geo-fencing information indicating an initial geo-fencing area. Additionally, the core network node may generate a second PWS message request, including a second message identifier (e.g.., including a specific message identifier and a serial number) and subsequent geo-fencing information indicating a subsequent geo-fencing area. In some aspects, the first PWS message request and the second PWS message request may correspond, respectively, to the first PWS message and the second PWS message described in connection with FIG. 4A. For example, upon receiving the broadcast request, the core network node may analyze the type of emergency and the designated target area, enabling the UE to prioritize the transmission of messages accordingly. In this way, processing the PWS broadcast request may allow the core network node to efficiently manage network resources and ensure appropriate response to different alert types.

In some aspects, as shown by reference number 445, the core network node may transmit (e.g., to a mobility management function, including an AMF or an MME, among other examples) a first PWS message request based on the PWS broadcast request, wherein the first PWS message request includes a first message identifier (e.g., including a specific message identifier and a serial number) and initial geo-fencing information indicating an initial geo-fencing area. In some aspects, the first PWS message request may cause a RAN network node to broadcast the first PWS message described in connection with FIG. 4A. For example, the first message request may specify the coordinates of an area affected by a natural disaster, such as a hurricane. In this way, transmitting a first PWS message request may enable additional core network functions to facilitate a RAN network node broadcasting a first PWS message to UEs in communication with the RAN network node.

In some aspects, the core network node may include initial geo-fencing information in the first PWS message request. For example, the geo-fencing information may define a boundary within which all UEs may receive the notification. In this way, including initial geo-fencing information may help ensure that alerts are only displayed to users within the relevant geographic area, minimizing distraction and confusion for those outside the danger zone.

In some aspects, the core network node may include different quantities of data or information (e.g., message content, geo-fencing information, or the like) for the first PWS message request and the second PWS message request. For example, the first PWS message request may provide a concise geo-fencing area description, while the second PWS message request may include a larger, more detailed geo-fencing area description.

In some aspects, as shown by reference number 450, the core network node may transmit (e.g., to a mobility management function, including an AMF or an MME, among other examples) a second PWS message request based on the PWS broadcast request, wherein the second PWS message request may include a second message identifier (e.g., including a specific message identifier or a serial number) and message content. In some aspects, the second PWS message request may cause a RAN network node to broadcast the second PWS message described in connection with FIG. 4A. For example, after the first PWS message request notification is sent, the core network node may send a second PWS message request containing detailed safety instructions or updates about the situation. In this way, transmitting a second PWS message request may enable a RAN network node to provide UE users with comprehensive information to make informed decisions during an emergency. In this way, transmitting a second PWS message request may enable additional core network functions to facilitate a RAN network node broadcasting a second PWS message to UEs in communication with the RAN network node.

In some aspects, the second PWS message request may include subsequent geo-fencing information indicating a subsequent geo-fencing area. For example, the second request may indicate an expanded area of interest due to evolving conditions of the emergency. Alternatively, the second PWS message request may not include subsequent geo-fencing information indicating a subsequent geo-fencing area. For example, the secondary notification may provide additional details on the emergency without changing the geographic scope. In some aspects, the subsequent geo-fencing area may be different from the initial geo-fencing area.

In some aspects, the core network node may include message content in the second PWS message request. For example, the message content may include specific steps for individuals to take, such as seeking shelter or avoiding certain areas, based on the nature of the threat. In this way, including message content in the second PWS message request may ensure that UE users receive actionable guidance to enhance their safety and preparedness during emergencies.

In some aspects, the core network node may link the first PWS message request and the second PWS message request via a serial number or a message identifier. For example, one or more core network functions or a RAN network node may adapt the respective serial numbers or message identifiers to a first PWS message and a second PWS message transmitted to a UE, thereby enabling the UE to accurately identify PWS message as being related.

As described herein, a UE may manage a plurality of PWS messages based on geo-fencing data, message content, and message identifier or serial number identification. In some aspects, the UE may receive a first PWS message with initial geo-fencing information and a second PWS message which may include more detailed geo-fencing data. The UE may refrain from displaying the first PWS message if the UE is located outside the initial geo-fencing area, and the UE may store the first PWS message for potential future use. Upon receiving the second PWS message, the UE may compare the serial numbers of the messages to determine if they pertain to the same event. If the serial numbers match, the UE may display the content of the second PWS message, which may supersede the primary notification. As a result, the second PWS message may provide subsequent geo-fencing information, and the UE may display the message content based upon the UE being inside the subsequent geo-fencing area. Additionally, the UE may discard or retain the first PWS message based on whether it is a PN or based on the comparative detail of geo-fencing information included in the second PWS message.

As a result, by utilizing message identifier or serial number matching and geo-fencing information, the described techniques may improve the UE’s ability to prioritize and process relevant emergency notifications, thereby conserving processing resources by avoiding display or storage of irrelevant warnings. Additionally, by dynamically managing notifications based on geo-fencing data and serial number linkage, the system may reduce network resource consumption by minimizing the transmission and processing of redundant or irrelevant alerts. In this way, the system may adapt to regional emergency communication systems in PWS operations, thereby enabling efficient utilization of network and computing resources.

As indicated above, FIGS. 4A-4B are provided as an example. Other examples may differ from what is described with regard to FIGS. 4A-4B.

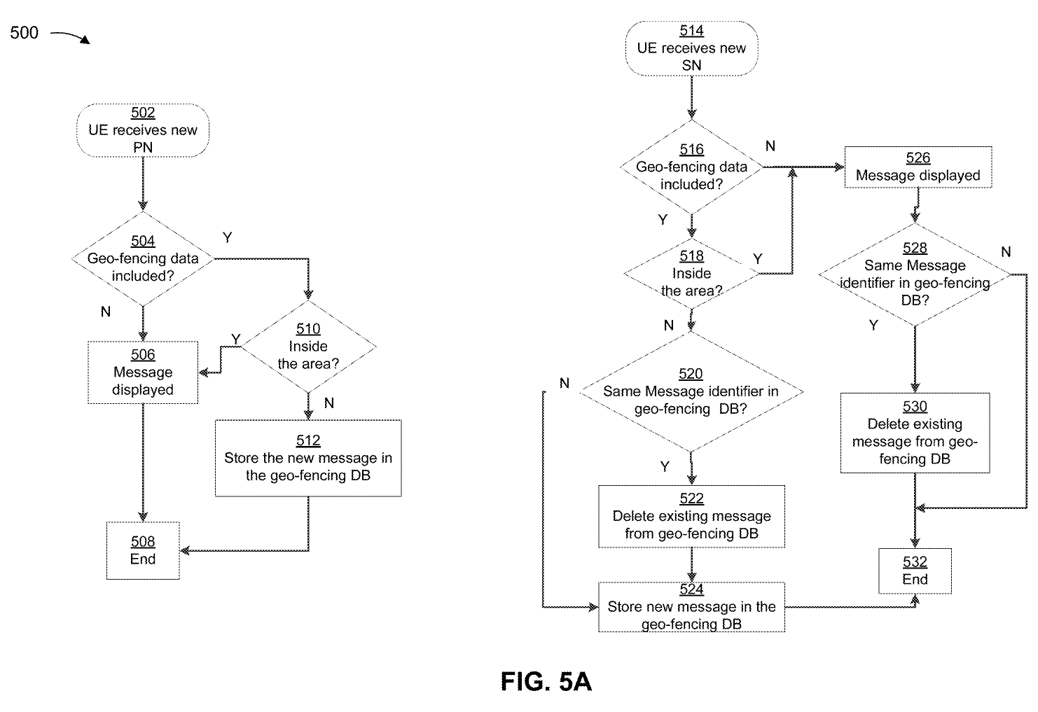

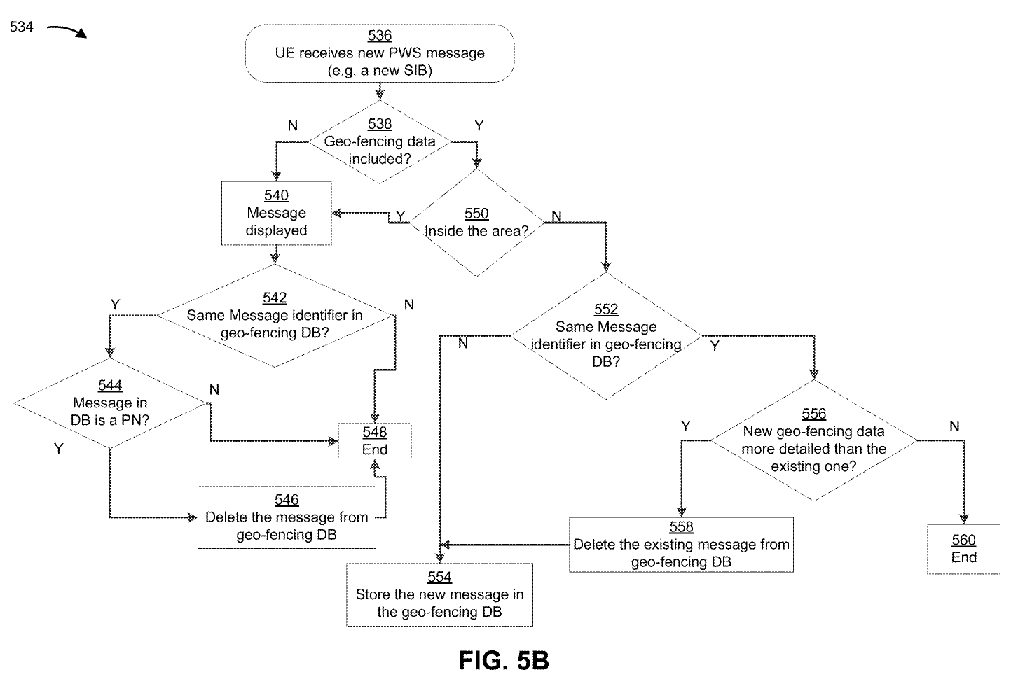

FIGS. 5A-5B are diagrams of example implementations 500 and 534 associated with PWS notifications.

As shown in FIG. 5A, and by reference number 502, a UE may receive a new PN. As further shown by reference number 504, the UE may determine whether geo-fencing data is included in the PN. In some aspects, this step may include assessing if geographical boundary data is attached to the notification. Additionally, or alternatively, it may involve checking for the presence of location-specific information in the message, which may assist in determining the relevance of the alert to the UE’s current location. Additionally, or alternatively, the step may include determining if the message contains geographic location conditions, which aid in tailoring the alert to users within specific zones.

If geo-fencing data is not included in the PN, as shown by reference number 506, the UE may display the message content of the PN to the user of the UE. Additionally, or alternatively, the message content of the PN may be displayed to a user interface, allowing for user interaction and acknowledgment. As shown by reference number 508, the process may end after the display of the message content of the PN to the user of the UE.

Alternatively, if geo-fencing data is included in the PN, as shown by reference number 510, the UE may determine if the UE is located inside an indicated geo-fencing area. In some aspects, this step may include verifying if the device is within an indicated geographical boundary, thereby ensuring the relevance of the PN to the UE’s location.

If the UE is within the geo-fencing area, the message content of the PN may be displayed to the user, as shown by reference number 506, and as described herein. Following the display of the message content, the process may end, as shown by reference number 508.

Alternatively, if the UE is not within the geo-fencing area, as shown by reference number 512, the UE may store the new message in a geo-fencing database for potential future use. For example, the UE may retain a PN because the PN may become relevant based on the UE’s location changing (e.g., the UE may move into the geo-fencing area).

As shown by reference number 514, the UE may receive a new SN. In some aspects, the SN may include additional details or updates about an ongoing event. As further shown by reference number 516, the UE may determine if geo-fencing data is included in the SN, as described herein. In some aspects, the UE may link the SN with a stored PWS message based on a matching message identifier (e.g., a matching combination of a message identifier and a serial number). In some aspects, in a case in which the SN is linked with the stored PWS message and the geo-fencing data of the SN includes a larger quantity of data than geo-fencing data of the stored PWS message, the UE may determine that the stored PWS message is a PN and that the SN is associated with the same warning or emergency as the stored PWS message. Additionally, or alternatively, in a case in which a subsequently received PWS message is linked with a stored PWS message and geo-fencing data of the subsequently received PWS message includes a smaller quantity of data than geo-fencing data of the stored PWS message, the UE may determine that the stored PWS message is not a PN. For example, because an SN may include more detailed geo-fencing information than a PN, comparative detail of geo-fencing information may be used to infer whether a particular PWS message is a PN or an SN.

If geo-fencing data is included in the SN, the UE determines whether the UE is located inside the geo-fencing area, as shown by reference number 518. If the UE is inside the geo-fencing area, as shown by reference number 526, the UE may display the message content of the SN. Alternatively, if the UE is not inside the geo-fencing area, as shown by reference number 520, the UE may determine if there the SN includes a message identifier (e.g., a message identifier and a serial number) that matches a message identifier (e.g., a message identifier and a serial number) of a PWS message that is stored in a geo-fencing database (e.g., in a database integrated in the UE or in communication with the UE). If the geo-fencing database includes a PWS message having a message identifier (e.g., a message identifier and a serial number) that matches the message identifier (e.g., a message identifier and a serial number) of the SN, as shown by reference number 522, the existing PWS message may be deleted from the geo-fencing database. In this way, the UE may retain the most current SN, which may include a larger of quantity of information relative to the existing message. For example, the existing message may be a PN that includes a smaller quantity of information relative to the SN. In some aspects, the UE may determine that the existing PWS message is a PN based on determining that geo-fencing data of the SN includes a larger quantity of data than geo-fencing data of the existing PWS message. As a result, and as shown by reference number 524, the UE may store the new SN in the geo-fencing database.

Alternatively, and as shown by reference number 526, if geo-fencing data is not included in the SN, the UE may display the message content of the SN. As shown by reference number 528, if the geo-fencing database includes a PWS message having a message identifier (e.g., a message identifier and a serial number) that matches the message identifier (e.g., a message identifier and a serial number) of the SN, the existing PWS message may be deleted from the geo-fencing database, as shown by reference number 530. In this way, the UE may retain the most current SN, which may include a larger of quantity of information relative to the existing message. For example, the existing message may be a PN that includes a smaller quantity of information relative to the SN.

Alternatively, and as shown by reference number 532, if the SN includes a message identifier (e.g., a message identifier and a serial number) that does not match a message identifier (e.g., a message identifier and a serial number) of the existing PWS message, the process may end.

As shown in FIG. 5B, and by reference number 536, a UE may receive a new PWS message. For example, the UE may receive a message as part of a PWS broadcast, which may include a new PWS message that includes message identifiers (e.g., a message identifier and a serial number) and geo-fencing data (e.g., geo-fencing information). In some aspects, the new PWS message may be received in a SIB. In some aspects, the UE may be unable to determine, based on the new PWS message, whether the new PWS message is a PN or an SN. As further shown by reference number 538, the UE may determine whether geo-fencing data is included in the new PWS message.

If geo-fencing data is not included, as shown by reference number 540, the UE may display the message content of the new PWS message. Subsequently, the UE may determine whether the new PWS message includes a message identifier (e.g., a message identifier and a serial number) that matches a message identifier (e.g., a message identifier and a serial number) of an existing message stored in a geo-fencing database, as shown by reference number 542. If such a message exists in the geo-fencing database, the UE further determines whether the message in the geo-fencing database is a PN, as shown by reference number 544. As shown by reference number 546, if the existing message in the geo-fending database is a PN, the existing message is deleted from the geo-fencing database. For example, the UE may implicitly determine that because the existing message in the geo-fencing database is a PN, the new PWS message is an SN, which may supersede the PN. In this way, and as shown by reference number 548, the process may end.

Alternatively, and as shown by reference number 542, the UE may determine that the new PWS message includes a message identifier (e.g., a message identifier and a serial number) that does not match a message identifier (e.g., a message identifier and a serial number) of an existing message stored in the geo-fencing database. As a result, and as shown by reference number 548, the process may end. For example, because there are no messages stored in the geo-fencing database, the system may store the new PWS message for processing if a newer PWS message is received.

Alternatively, and as shown by reference number 550, if geo-fencing data is included in the new PWS message, the UE determines whether the UE is located inside the indicated geo-fencing area. If the UE is inside the geo-fencing area, the UE may display the message to the user of the UE. In this way, the process may proceed to reference number 542, as described herein.

However, if the UE determines that the UE is located outside the geo-fencing area, the UE may determine whether the new PWS message includes a message identifier (e.g., a message identifier and a serial number) that matches a message identifier (e.g., a message identifier and a serial number) of an existing PWS message stored in the geo-fencing database, as shown by reference number 552. If no such PWS message exists in the geo-fencing database, the UE stores the new PWS message in the geo-fencing database, as shown by reference number 554 (e.g., for future reference if the UE moves into the geo-fenced area.)

Alternatively, if the UE determines that the new PWS message includes a message identifier (e.g., a message identifier and a serial number) that matches a message identifier (e.g., a message identifier and a serial number) of an existing message stored in a geo-fencing database, the UE may determine whether the geo-fencing data of the new PWS message is more detailed (e.g., contains a larger quantity of data) than geo-fencing data of the PWS message stored in the geo-fencing database, as shown by reference number 556. In some aspects, the UE may determine that the PWS message stored in the geo-fencing database is a PN based on determining that the geo-fencing data of the new PWS message includes a larger quantity of data than the geo-fencing data of the PWS message stored in the geo-fencing database. Additionally, or alternatively, the UE may determine that the PWS message stored in the geo-fencing database is not a PN based on determining that the geo-fencing data of the new PWS message includes a smaller quantity of data than the geo-fencing data of the PWS message stored in the geo-fencing database.

If the data of the new PWS message is more detailed than the geo-fencing data of the PWS message stored in the geo-fencing database, the UE may delete the existing message from the geo-fencing database, as shown by reference number 558. As shown by reference number 554, the UE may then store the new PWS message. For example, where the new PWS message is more detailed than the existing PWS message stored in the geo-fencing database, the new PWS message may be an SN. Accordingly, because the SN may include more information relative to a PN, the UE may store the SN so that it may be displayed if the UE enters the geo-located area.

Alternatively, if the data of the new PWS message is not more detailed than the geo-fencing data of the PWS message stored in the geo-fencing database, the process ends without updating the database, as shown by reference number 560. For example, where the new PWS message is not more detailed than the existing PWS message stored in the geo-fencing database, the new PWS message may be a PN, and the existing PWS message may be an SN. Because an SN includes more information relative to a PN, the UE may retain the SN so that it may be displayed if the UE enters the geo-located area. In other words, the UE may have first received an SN, and the new PWS message may be a PN that was received after the SN.

As described herein, a UE may manage a plurality of PWS messages based on geo-fencing data, message content, and message identifier or serial number identification. In some aspects, the UE may receive a first PWS message with initial geo-fencing information and a second PWS message which may include more detailed geo-fencing data. The UE may refrain from displaying the first PWS message if the UE is located outside the initial geo-fencing area, and the UE may store the first PWS message for potential future use. Upon receiving the second PWS message, the UE may compare the serial numbers of the messages to determine if they pertain to the same event. If the serial numbers match, the UE may display the content of the second PWS message, which may supersede the primary notification. As a result, the second PWS message may provide subsequent geo-fencing information, and the UE may display the message content based upon the UE being inside the subsequent geo-fencing area. Additionally, the UE may discard or retain the first PWS message based on whether it is a PN or based on the comparative detail of geo-fencing information included in the second PWS message. In some aspects, the subsequent geo-fencing area may be different from the initial geo-fencing area.

As a result, by utilizing message identifier or serial number matching and geo-fencing information, the described techniques may improve the UE’s ability to prioritize and process relevant emergency notifications, thereby conserving processing resources by avoiding display or storage of irrelevant warnings. Additionally, by dynamically managing notifications based on geo-fencing data and serial number linkage, the system may reduce network resource consumption by minimizing the transmission and processing of redundant or irrelevant alerts. In this way, the system may adapt to regional emergency communication systems in PWS operations, thereby enabling efficient utilization of network and computing resources.

As indicated above, FIGS. 5A-5B are provided as an example. Other examples may differ from what is described with regard to FIGS. 5A-5B.

FIG. 6 is a diagram illustrating an example process 600 performed, for example, at a UE or an apparatus of a UE. Example process 600 is an example where the apparatus or the UE (e.g., UE 120) performs operations associated with PWS notifications.

As shown in FIG. 6, in some aspects, process 600 may include receiving a first PWS message, where the first PWS message includes a first message identifier and initial geo-fencing information indicating an initial geo-fencing area (block 610). For example, the UE (e.g., using reception component 902 or communication manager 906, depicted in FIG. 9) may receive a first PWS message, where the first PWS message includes a first message identifier and initial geo-fencing information indicating an initial geo-fencing area, as described above.

As further shown in FIG. 6, in some aspects, process 600 may include refraining from displaying the first PWS message based on a determination that the UE is located outside of the initial geo-fencing area, where the first PWS message is stored by the UE (block 620). For example, the UE (e.g., using communication manager 906, depicted in FIG. 9) may refrain from displaying the first PWS message based on a determination that the UE is located outside of the initial geo-fencing area, where the first PWS message may be stored by the UE, as described above.

As further shown in FIG. 6, in some aspects, process 600 may include receiving a second PWS message, where the second PWS message includes a second message identifier and message content (block 630). For example, the UE (e.g., using reception component 902 or communication manager 906, depicted in FIG. 9) may receive a second PWS message, where the second PWS message includes a second message identifier and message content, as described above.

As further shown in FIG. 6, in some aspects, process 600 may include discarding the first PWS message based on a determination that the first message identifier matches the second message identifier (block 640). For example, the UE (e.g., using communication manager 906, depicted in FIG. 9) may discard the first PWS message based on a determination that the first message identifier matches the second message identifier, as described above.

Process 600 may include additional aspects, such as any single aspect or any combination of aspects described below or in connection with one or more other processes described elsewhere herein.

In a first aspect, the second PWS message includes subsequent geo-fencing information indicating a subsequent geo-fencing area.

In a second aspect, process 600 includes displaying the message content of the second PWS message based on a determination that the UE is located inside of the subsequent geo-fencing area.

In a third aspect, process 600 includes refraining from discarding the first PWS message based on a determination that the first PWS message is not a primary notification.

In a fourth aspect, process 600 includes discarding the first PWS message based on a determination that the first PWS message is a primary notification.

In a fifth aspect, process 600 includes refraining from discarding the first PWS message based on a determination that the subsequent geo-fencing information includes a smaller quantity of data than the initial geo-fencing information.

In a sixth aspect, process 600 includes discarding the first PWS message based on a determination that the subsequent geo-fencing information includes a larger quantity of data than the initial geo-fencing information.

In a seventh aspect, process 600 includes refraining from displaying the message content of the second PWS message based on a determination that the UE is located outside of the subsequent geo-fencing area.

In an eighth aspect, process 600 includes storing the second PWS message based on a determination that the first message identifier does not match the second message identifier.

In a ninth aspect, displaying the message content of the second PWS message is further based on the UE being unable to determine a location of the UE.

In a tenth aspect, the second PWS message does not include subsequent geo-fencing information indicating a subsequent geo-fencing area.

In an eleventh aspect, process 600 includes discarding the first PWS message based upon receipt of the second PWS message.

In a twelfth aspect, displaying the message content of the second PWS message is further based on a determination that the UE is located inside of the initial geo-fencing area.

In a thirteenth aspect, the first PWS message is received in a first SIB and the second PWS message is received in a second SIB.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, at a RAN network node or an apparatus of a RAN network node. Example process 700 is an example where the apparatus or the RAN network node (e.g., network node 110) performs operations associated with PWS notifications.

As shown in FIG. 7, in some aspects, process 700 may include transmitting, to a UE, a first PWS message, where the first PWS message includes a first message identifier and initial geo-fencing information indicating an initial geo-fencing area (block 710). For example, the RAN network node (e.g., using transmission component 1004 or communication manager 1006, depicted in FIG. 10) may transmit, to a UE, a first PWS message, where the first PWS message includes a first message identifier and initial geo-fencing information indicating an initial geo-fencing area, as described above.

As further shown in FIG. 7, in some aspects, process 700 may include transmitting, to the UE, a second PWS message, where the second PWS message includes a second message identifier and message content, and where the first message identifier matches the second message identifier (block 720). For example, the RAN network node (e.g., using transmission component 1004 or communication manager 1006, depicted in FIG. 10) may transmit, to the UE, a second PWS message, where the second PWS message includes a second message identifier and message content, and where the first message identifier matches the second message identifier, as described above.

Process 700 may include additional aspects, such as any single aspect or any combination of aspects described below or in connection with one or more other processes described elsewhere herein.

In a first aspect, the second PWS message includes subsequent geo-fencing information indicating a subsequent geo-fencing area.

In a second aspect, the second PWS message does not include subsequent geo-fencing information indicating a subsequent geo-fencing area.

In a third aspect, the first PWS message is transmitted in a first SIB and the second PWS message is transmitted in a second SIB.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, at a core network node or an apparatus of a core network node. Example process 800 is an example where the apparatus or the core network node (e.g., core network node 170) performs operations associated with PWS notifications.

As shown in FIG. 8, in some aspects, process 800 may include receiving, from a cell broadcast entity, a PWS broadcast request (block 810). For example, the core network node (e.g., using reception component 1102 or communication manager 1106, depicted in FIG. 11) may receive, from a cell broadcast entity, a PWS broadcast request, as described above.

As further shown in FIG. 8, in some aspects, process 800 may include transmitting a first PWS message request based on the PWS broadcast request, where the first PWS message request includes a first message identifier and initial geo-fencing information indicating an initial geo-fencing area (block 820). For example, the core network node (e.g., using transmission component 1104 or communication manager 1106, depicted in FIG. 11) may transmit a first PWS message request based on the PWS broadcast request, where the first PWS message request includes a first message identifier and initial geo-fencing information indicating an initial geo-fencing area, as described above.

As further shown in FIG. 8, in some aspects, process 800 may include transmitting a second PWS message request based on the PWS broadcast request, where the second PWS message request includes a second message identifier and message content, and where the first message identifier matches the second message identifier (block 830). For example, the core network node (e.g., using transmission component 1104 or communication manager 1106, depicted in FIG. 11) may transmit a second PWS message request based on the PWS broadcast request, where the second PWS message request includes a second message identifier and message content, and where the first message identifier matches the second message identifier, as described above.

Process 800 may include additional aspects, such as any single aspect or any combination of aspects described below or in connection with one or more other processes described elsewhere herein.

In a first aspect, the second PWS message request includes subsequent geo-fencing information indicating a subsequent geo-fencing area.

In a second aspect, the second PWS message request does not include subsequent geo-fencing information indicating a subsequent geo-fencing area.

In a third aspect, the core network node is related to a cell broadcast center function.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication. The apparatus 900 may be a UE, or a UE may include the apparatus 900. In some aspects, the apparatus 900 includes a reception component 902, a transmission component 904, or a communication manager 906, which may be in communication with one another (for example, via one or more buses or one or more other components). In some aspects, the communication manager 906 is the communication manager 150 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 140 described in connection with FIG. 1) of the UE.

In some aspects, the apparatus 900 may be configured to perform one or more operations described herein in connection with FIGS. 4A, 4B, 5A, or 5B. Additionally, or alternatively, the apparatus 900 may be configured to perform one or more processes described herein, such as process 600 of FIG. 6. In some aspects, the apparatus 900 or one or more components shown in FIG. 9 may include one or more components of the UE described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the UE described above in connection with FIG. 1, such as a radio, one or more RF chains, one or more transceivers, or one or more modems, each of which may in turn be coupled with one or more antennas of the UE.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 904 may be co-located with the reception component 902.

The communication manager 906 may support operations of the reception component 902 or the transmission component 904. For example, the communication manager 906 may receive information associated with configuring reception of communications by the reception component 902 or transmission of communications by the transmission component 904. Additionally, or alternatively, the communication manager 906 may generate or provide control information to the reception component 902 or the transmission component 904 to control reception or transmission of communications.

The reception component 902 may receive a first PWS message, where the first PWS message includes a first message identifier and initial geo-fencing information indicating an initial geo-fencing area. The communication manager 906 may refrain from displaying the first PWS message based on a determination that the UE is located outside of the initial geo-fencing area, where the first PWS message is stored by the UE. The reception component 902 may receive a second PWS message, where the second PWS message includes a second message identifier and message content. The communication manager 906 may discard the first PWS message based on a determination that the first message identifier matches the second message identifier.

The communication manager 906 may refrain from discarding the first PWS message based on a determination that the first PWS message is not a primary notification.

The communication manager 906 may discard the first PWS message based on a determination that the first PWS message is a primary notification.

The communication manager 906 may refrain from discarding the first PWS message based on a determination that the subsequent geo-fencing information includes a smaller quantity of data than the initial geo-fencing information.

The communication manager 906 may discard the first PWS message based on a determination that the subsequent geo-fencing information includes a larger quantity of data than the initial geo-fencing information.

The communication manager 906 may store the second PWS message based on a determination that the first message identifier does not match the second message identifier.

The communication manager 906 may store the second PWS message based on a determination that the UE is located outside of the subsequent geo-fencing area.

The communication manager 906 may discard the first PWS message based upon receipt of the second PWS message.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication. The apparatus 1000 may be a RAN network node, or a RAN network node may include the apparatus 1000. In some aspects, the apparatus 1000 includes a reception component 1002, a transmission component 1004, or a communication manager 1006, which may be in communication with one another (for example, via one or more buses or one or more other components). In some aspects, the communication manager 1006 is the communication manager 155 described in connection with FIG. 1. As shown, the apparatus 1000 may communicate with another apparatus 1008, such as a UE or a network node (such as a CU, a DU, an RU, a core network node, or a base station), using the reception component 1002 and the transmission component 1004. The communication manager 1006 may be included in, or implemented via, a processing system (for example, the processing system 145 described in connection with FIG. 1) of the RAN network node.

In some aspects, the apparatus 1000 may be configured to perform one or more operations described herein in connection with FIGS. 4A, 4B, 5A, or 5B. Additionally, or alternatively, the apparatus 1000 may be configured to perform one or more processes described herein, such as process 700 of FIG. 7. In some aspects, the apparatus 1000 or one or more components shown in FIG. 10 may include one or more components of the RAN network node described in connection with FIG. 1. Additionally, or alternatively, one or more components shown in FIG. 10 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications, and may provide the processed signals to the one or more other components of the apparatus 1000. In some aspects, the reception component 1002 may include one or more components of the RAN network node described above in connection with FIG. 1, such as a radio, one or more RF chains, one or more transceivers, or one or more modems, each of which may in turn be coupled with one or more antennas of the RAN network node. In some aspects, the reception component 1002 or the transmission component 1004 may include or may be included in a network interface. The network interface may be configured to obtain or output signals for the apparatus 1000 via one or more communications links, such as a backhaul link, a midhaul link, or a fronthaul link.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications, and may transmit the processed signals to the apparatus 1008. In some aspects, the transmission component 1004 may include one or more components of the RAN network node described above in connection with FIG. 1, such as a radio, one or more RF chains, one or more transceivers, or one or more modems, each of which may in turn be coupled with one or more antennas of the RAN network node described in connection with FIG. 1. In some aspects, the transmission component 1004 may be co-located with the reception component 1002.

The communication manager 1006 may support operations of the reception component 1002 or the transmission component 1004. For example, the communication manager 1006 may receive information associated with configuring reception of communications by the reception component 1002 or transmission of communications by the transmission component 1004. Additionally, or alternatively, the communication manager 1006 may generate or provide control information to the reception component 1002 or the transmission component 1004 to control reception or transmission of communications.

The transmission component 1004 may transmit, to a UE, a first PWS message, where the first PWS message includes a first message identifier and initial geo-fencing information indicating an initial geo-fencing area. The transmission component 1004 may transmit, to the UE, a second PWS message, where the second PWS message includes a second message identifier and message content, and where the first message identifier matches the second message identifier.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication. The apparatus 1100 may be a core network node (e.g., core network node 170), or a core network node may include the apparatus 1100. In some aspects, the apparatus 1100 includes a reception component 1102, a transmission component 1104, or a communication manager 1106, which may be in communication with one another (for example, via one or more buses or one or more other components). In some aspects, the communication manager 1106 is the communication manager 185 described in connection with FIG. 1. As shown, the apparatus 1100 may communicate with another apparatus 1108, such as a UE or a network node (such as a CU, a DU, an RU, or a base station), using the reception component 1102 and the transmission component 1104. The communication manager 1106 may be included in, or implemented via, a processing system (for example, the processing system 180 described in connection with FIG. 1) of the core network node.

In some aspects, the apparatus 1100 may be configured to perform one or more operations described herein in connection with FIGS. 4A, 4B, 5A, or 5B. Additionally, or alternatively, the apparatus 1100 may be configured to perform one or more processes described herein, such as process 800 of FIG. 8. In some aspects, the apparatus 1100 or one or more components shown in FIG. 11 may include one or more components of the core network node described in connection with FIG. 1. Additionally, or alternatively, one or more components shown in FIG. 11 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications, and may provide the processed signals to the one or more other components of the apparatus 1100. In some aspects, the reception component 1102 may include one or more components of the core network node described above in connection with FIG. 1, such as a radio, one or more RF chains, one or more transceivers, or one or more modems, each of which may in turn be coupled with one or more antennas of the core network node. In some aspects, the reception component 1102 or the transmission component 1104 may include or may be included in a network interface. The network interface may be configured to obtain or output signals for the apparatus 1100 via one or more communications links, such as a backhaul link, a midhaul link, or a fronthaul link.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications, and may transmit the processed signals to the apparatus 1108. In some aspects, the transmission component 1104 may include one or more components of the core network node described above in connection with FIG. 1, such as a radio, one or more RF chains, one or more transceivers, or one or more modems, each of which may in turn be coupled with one or more antennas of the core network node described in connection with FIG. 1. In some aspects, the transmission component 1104 may be co-located with the reception component 1102.

The communication manager 1106 may support operations of the reception component 1102 or the transmission component 1104. For example, the communication manager 1106 may receive information associated with configuring reception of communications by the reception component 1102 or transmission of communications by the transmission component 1104. Additionally, or alternatively, the communication manager 1106 may generate or provide control information to the reception component 1102 or the transmission component 1104 to control reception or transmission of communications.

The reception component 1102 may receive, from a cell broadcast entity, a PWS broadcast request. The transmission component 1104 may transmit a first PWS message request based on the PWS broadcast request, where the first PWS message request includes a first message identifier and initial geo-fencing information indicating an initial geo-fencing area. The transmission component 1104 may transmit a second PWS message request based on the PWS broadcast request, where the second PWS message request includes a second message identifier and message content, and where the first message identifier matches the second message identifier.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a user equipment (UE), comprising: receiving a first public warning system (PWS) message, wherein the first PWS message includes a first message identifier and initial geo-fencing information indicating an initial geo-fencing area; refraining from displaying the first PWS message based on a determination that the UE is located outside of the initial geo-fencing area, wherein the first PWS message is stored by the UE; receiving a second PWS message, wherein the second PWS message includes a second message identifier and message content; and discarding the first PWS message based on a determination that the first message identifier matches the second message identifier.

Aspect 2: The method of Aspect 1, The UE of Aspect 1 wherein the first PWS message includes a first serial number and the second PWS message includes a second serial number, and the discarding of the first PWS message is further based on a determination that the first serial number matches the second serial number.

Aspect 3: The method of any of Aspects 1-2, wherein the second PWS message includes subsequent geo-fencing information indicating a subsequent geo-fencing area.

Aspect 4: The method of Aspect 3, further comprising: displaying the message content of the second PWS message based on a determination that the UE is located inside of the subsequent geo-fencing area.

Aspect 5: The method of Aspect 4, further comprising: refraining from discarding the first PWS message based on a determination that the first PWS message is not a primary notification.

Aspect 6: The method of Aspect 4, further comprising: discarding the first PWS message based on a determination that the first PWS message is a primary notification.

Aspect 7: The method of Aspect 1, further comprising: refraining from displaying the message content of the second PWS message based on a determination that the UE is located outside of the subsequent geo-fencing area.

Aspect 8: The method of Aspect 4, wherein displaying the message content of the second PWS message is further based on the UE being unable to determine a location of the UE.

Aspect 9: The method of Aspect 4, wherein displaying the message content of the second PWS message is further based on a determination that the UE is located inside of the initial geo-fencing area.

Aspect 10: The method of Aspect 3, further comprising: refraining from discarding the first PWS message based on a determination that the subsequent geo-fencing information includes a smaller quantity of data than the initial geo-fencing information.

Aspect 11: The method of Aspect 3, further comprising: discarding the first PWS message based on a determination that the subsequent geo-fencing information includes a larger quantity of data than the initial geo-fencing information.

Aspect 12: The method of any of Aspects 1-11, further comprising: storing the second PWS message based on a determination that the UE is located outside of the subsequent geo-fencing area.

Aspect 13: The method of any of Aspects 1-12, wherein the second PWS message does not include subsequent geo-fencing information indicating a subsequent geo-fencing area.

Aspect 14: The method of Aspect 13, further comprising: refraining from discarding the first PWS message based on a determination that the first PWS message is not a primary notification.

Aspect 15: The method of Aspect 13, further comprising: discarding the first PWS message based on a determination that the first PWS message is a primary notification.

Aspect 16: The method of Aspect 13, further comprising: discarding the first PWS message based upon receipt of the second PWS message.

Aspect 17: The method of any of Aspects 1-16, wherein the first PWS message is received in a first system information block (SIB) and the second PWS message is received in a second SIB.

Aspect 18: A method of wireless communication performed by a radio access network (RAN) network node, comprising: transmitting, to a user equipment (UE), a first public warning system (PWS) message, wherein the first PWS message includes a first message identifier and initial geo-fencing information indicating an initial geo-fencing area; and transmitting, to the UE, a second PWS message, wherein the second PWS message includes a second message identifier and message content, and wherein the first message identifier matches the second message identifier.

Aspect 19: The method of Aspect 18, wherein the first PWS message includes a first serial number and the second PWS message includes a second serial number, and the first serial number matches the second serial number.

Aspect 20: The method of any of Aspects 18-19, wherein the second PWS message includes subsequent geo-fencing information indicating a subsequent geo-fencing area.

Aspect 21: The method of any of Aspects 18-20, wherein the second PWS message does not include subsequent geo-fencing information indicating a subsequent geo-fencing area.

Aspect 22: The method of any of Aspects 18-21, wherein the first PWS message is transmitted in a first system information block (SIB) and the second PWS message is transmitted in a second SIB.

Aspect 23: A method of wireless communication performed by a core network node, comprising: receiving, from a cell broadcast entity, a public warning system (PWS) broadcast request; transmitting a first PWS message request based on the PWS broadcast request, wherein the first PWS message request includes a first message identifier and initial geo-fencing information indicating an initial geo-fencing area; and transmitting a second PWS message request based on the PWS broadcast request, wherein the second PWS message request includes a second message identifier and message content, and wherein the first message identifier matches the second message identifier.

Aspect 24: The method of Aspect 23, wherein the first PWS message request includes a first serial number and the second PWS message request includes a second serial number, and the first serial number matches the second serial number.

Aspect 25: The method of any of Aspects 23-24, wherein the second PWS message request includes subsequent geo-fencing information indicating a subsequent geo-fencing area.

Aspect 26: The method of any of Aspects 23-25, wherein the second PWS message request does not include subsequent geo-fencing information indicating a subsequent geo-fencing area.

Aspect 27: The method of any of Aspects 23-26, wherein the core network node is related to a cell broadcast center function.

Aspect 28: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-27.

Aspect 29: An apparatus for wireless communication at a device, the apparatus comprising one or more memories and one or more processors coupled to the one or more memories, the one or more processors configured to cause the device to perform the method of one or more of Aspects 1-27.

Aspect 30: An apparatus for wireless communication, the apparatus comprising at least one means for performing the method of one or more of Aspects 1-27.

Aspect 31: A non-transitory computer-readable medium storing code for wireless communication, the code comprising instructions executable by one or more processors to perform the method of one or more of Aspects 1-27.

Aspect 32: A non-transitory computer-readable medium storing a set of instructions for wireless communication, the set of instructions comprising one or more instructions that, when executed by one or more processors of a device, cause the device to perform the method of one or more of Aspects 1-27.

Aspect 33: A device for wireless communication, the device comprising a processing system that includes one or more processors and one or more memories coupled with the one or more processors, the processing system configured to cause the device to perform the method of one or more of Aspects 1-27.

Aspect 34: An apparatus for wireless communication at a device, the apparatus comprising one or more memories and one or more processors coupled to the one or more memories, the one or more processors individually or collectively configured to cause the device to perform the method of one or more of Aspects 1-27.

Aspect 35: A device comprising a processing system that includes one or more processors and one or more code-storing memories coupled with the one or more processors, the processing system configured to cause the device to perform the method of one or more of Aspects 1-27.

Aspect 36: A device comprising a processing system that includes processor circuitry and code-storing memory circuitry, the processing system configured to cause the device to perform the method of one or more of Aspects 1-27.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes one or more processors and one or more code-storing memories coupled with the one or more processors, the processing system configured to cause the UE to:
receive a first public warning system (PWS) message, wherein the first PWS message includes a first message identifier and initial geo-fencing information indicating an initial geo-fencing area;
refrain from displaying the first PWS message based on a determination that the UE is located outside of the initial geo-fencing area, wherein the first PWS message is stored by the UE;
receive a second PWS message, wherein the second PWS message includes a second message identifier and message content; and
discard the first PWS message based on a determination that the first message identifier matches the second message identifier.

2. The UE of claim 1, wherein the first PWS message includes a first serial number and the second PWS message includes a second serial number, and wherein the discarding of the first PWS message is further based on a determination that the first serial number matches the second serial number.

3. The UE of claim 1, wherein the first PWS message is a primary notification and the first PWS message includes a first serial number and the second PWS message includes a second serial number.

4. The UE of claim 1, wherein the second PWS message includes subsequent geo-fencing information indicating a subsequent geo-fencing area.

5. The UE of claim 4, wherein the processing system is configured to cause the UE to:
display the message content of the second PWS message based on a determination that the UE is located inside of the subsequent geo-fencing area.

6. The UE of claim 5, wherein the processing system is configured to cause the UE to:
discard the first PWS message based on a determination that the first PWS message is a primary notification.

7. The UE of claim 5, wherein displaying the message content of the second PWS message is further based on a determination that the UE is located inside of the initial geo-fencing area.

8. The UE of claim 4, wherein the processing system is configured to cause the UE to:
discard the first PWS message based on a determination that the subsequent geo-fencing information includes a larger quantity of data than the initial geo-fencing information.

9. The UE of claim 4, wherein the processing system is configured to cause the UE to:
store the second PWS message based on a determination that the UE is located outside of the subsequent geo-fencing area.

10. The UE of claim 4, wherein displaying the message content of the second PWS message is further based on the UE being unable to determine a location of the UE.

11. The UE of claim 1, wherein the second PWS message does not include subsequent geo-fencing information indicating a subsequent geo-fencing area.

12. The UE of claim 11, wherein the processing system is configured to cause the UE to:
discard the first PWS message based on a determination that the first PWS message is a primary notification.

13. The UE of claim 11, wherein the processing system is configured to cause the UE to:
discard the first PWS message based upon receipt of the second PWS message.

14. The UE of claim 1, wherein the first PWS message is received in a first system information block (SIB) and the second PWS message is received in a second SIB.

15. A radio access network (RAN) network node, comprising:
a processing system that includes one or more processors and one or more code-storing memories coupled with the one or more processors, the processing system configured to cause the RAN network node to:
transmit, to a user equipment (UE), a first public warning system (PWS) message, wherein the first PWS message includes a first message identifier and initial geo-fencing information indicating an initial geo-fencing area; and
transmit, to the UE, a second PWS message, wherein the second PWS message includes a second message identifier and message content, and wherein the first message identifier matches the second message identifier.

16. A core network node, comprising:
a processing system that includes one or more processors and one or more code-storing memories coupled with the one or more processors, the processing system configured to cause the core network node to:
receive, from a cell broadcast entity, a public warning system (PWS) broadcast request;
transmit a first PWS message request based on the PWS broadcast request, wherein the first PWS message request includes a first message identifier and initial geo-fencing information indicating an initial geo-fencing area; and
transmit a second PWS message request based on the PWS broadcast request, wherein the second PWS message request includes a second message identifier and message content, and wherein the first message identifier matches the second message identifier.

17. A method of wireless communication performed by a user equipment (UE), comprising:
receiving a first public warning system (PWS) message, wherein the first PWS message includes a first message identifier and initial geo-fencing information indicating an initial geo-fencing area;
refraining from displaying the first PWS message based on a determination that the UE is located outside of the initial geo-fencing area, wherein the first PWS message is stored by the UE;
receiving a second PWS message, wherein the second PWS message includes a second message identifier and message content; and
discarding the first PWS message based on a determination that the first message identifier matches the second message identifier.

18. The method of claim 17, wherein the first PWS message includes a first serial number and the second PWS message includes a second serial number, and wherein the discarding of the first PWS message is further based on a determination that the first serial number matches the second serial number.

19. The method of claim 17, wherein the second PWS message includes subsequent geo-fencing information indicating a subsequent geo-fencing area.

20. The method of claim 17, wherein the first PWS message is a primary notification and the first PWS message includes a first serial number and the second PWS message includes a second serial number.

21. The method of claim 17, wherein the second PWS message includes subsequent geo-fencing information indicating a subsequent geo-fencing area.

22. The method of claim 21, further comprising:
displaying the message content of the second PWS message based on a determination that the UE is located inside of the subsequent geo-fencing area.

23. The method of claim 22, further comprising
discarding the first PWS message based on a determination that the first PWS message is a primary notification.

24. The method of claim 22, wherein displaying the message content of the second PWS message is further based on the UE being unable to determine a location of the UE.

25. The method of claim 22, wherein displaying the message content of the second PWS message is further based on a determination that the UE is located inside of the initial geo-fencing area.

26. The method of claim 22, further comprising:
discarding the first PWS message based on a determination that the first PWS message is a primary notification.

27. The method of claim 21, further comprising:
discarding the first PWS message based on a determination that the subsequent geo-fencing information includes a larger quantity of data than the initial geo-fencing information

28. The method of claim 17, wherein the second PWS message does not include subsequent geo-fencing information indicating a subsequent geo-fencing area.

29. The method of claim 28, further comprising:
discarding the first PWS message based on a determination that the first PWS message is a primary notification.

30. The method of claim 17, further comprising:
storing the second PWS message based on a determination that the UE is located outside of the subsequent geo-fencing area.
